(19) United States
(12) Patent Application Publication
(10) Pub. No.: US 2026/0104082 A1
(43) Pub. Date: Apr. 16, 2026

(54) CYLINDER DEVICE

(71) Applicant: Astemo, Ltd., Tokyo (JP)

(72) Inventors: Jordan TRUITT, Farmington Hills, MI (US); Takashi TSUKAHARA, Hitachinaka-shi (JP)

(21) Appl. No.: 19/333,461

(22) Filed: Sep. 19, 2025

Related U.S. Application Data
(63) Continuation-in-part of application No. 18/912,649, filed on Oct. 11, 2024.

(51) Int. Cl. F16F 9/348

(52) U.S. Cl. CPC F16F 9/3481; F16F 2222/12

(57) ABSTRACT

A cylinder device includes a piston slidably provided within a cylinder and configured to divide an inside of the cylinder into two chambers, a piston rod connected to the piston and configured to extend to an outside of the cylinder, a first passage through which a working fluid flows as the piston moves, a second passage through which the working fluid flows as the piston moves, and a damping force generating mechanism provided to the first passage and configured to generate a damping force, wherein the damping force generating mechanism includes a first valve that opens and closes the first passage, a second valve of which inner and outer circumferences are both movable in an axial direction and has a third passage through which the working fluid flowing out of the first passage flows, and a third valve of which an inner circumference is fixed and outer circumference is bent.

### BACKGROUND OF THE INVENTION

### Field of the Invention

The present invention relates to a cylinder device.

Priority is claimed on U.S. patent application Ser. No. 18/912,649, filed Oct. 11, 2024, the content of which is incorporated herein by reference.

### Description of Related Art

There is a cylinder device including an orifice disc and an intake valve disc for opening and closing a compression passage provided in a valve body, an interface provided on the side of the orifice disc and the intake valve disc opposite to the valve body, and an interface disc provided on the side of an interface opposite to the orifice disc and the intake valve disc (refer to, for example, Japanese Patent No. 5211166).

Incidentally, it is required that a damping force is adjustable in a low speed region in which a piston speed which is a movement speed of a piston in an axial direction is low, in a medium speed region in which the piston speed is higher than in the low speed region, and in a high speed region in which the piston speed is higher than in the medium speed region.

For example, there is a demand for a valve that has a damping force characteristic that increases the damping force when the piston speed is in the low speed region, and does not become too high in the medium to high speed regions.

However, in conventional valves that do not have an actuator, when the damping force in the low speed region in which the piston speed is small is increased, the damping force in the medium to high speed regions is also increased, and thus it is difficult to achieve both.

Therefore, an object of the present invention is to provide a cylinder device that is capable of adjusting a damping force in a low speed region in which a piston speed is low, and in a medium speed region in which the piston speed is higher than in the low speed region, and in a high speed region in which the piston speed is higher than in the medium speed region.

### SUMMARY OF THE INVENTION

In order to achieve the above object, one aspect of a cylinder device of the present invention includes a cylinder in which a working fluid is sealed, a piston slidably provided within the cylinder and configured to divide an inside of the cylinder into two chambers, a piston rod connected to the piston and configured to extend to an outside of the cylinder, a first passage through which a working fluid flows as the piston moves, a second passage through which the working fluid flows as the piston moves, and a damping force generating mechanism provided in the first passage and configured to generate a damping force, wherein the damping force generating mechanism includes a first valve that opens and closes the first passage, a second valve of which inner and outer circumferences are both movable in an axial direction and which has a third passage through which the working fluid flowing out of the first passage flows, and a third valve of which an inner circumference is fixed and an outer circumference is bent to adjust a biasing force of the first valve.

Another aspect of a cylinder device of the present invention includes a cylinder in which a working fluid is sealed, a piston slidably disposed within the cylinder and configured to divide an inside of the cylinder into two chambers, a piston rod connected to the piston and configured to extend to an outside of the cylinder, a first passage through which the working fluid flows as the piston moves, a second passage through which the working fluid flows as the piston moves, and a damping force generating mechanism provided to the first passage and configured to generate a damping force, wherein the damping force generating mechanism includes a first valve that opens and closes the first passage, a second valve of which inner and outer circumferences are both movable in an axial direction, a support member provided on an inner circumferential side of the second valve to support axial movement of the second valve and having a third passage configured to allow the working fluid flowing from the first passage to flow therethrough, and a third valve of which an inner circumference is fixed and an outer circumference is flexible to adjust a biasing force of the first valve.

According to the above aspect of the present invention, the damping force can be adjusted in a low speed region in which a piston speed is low, and in a medium speed region in which the piston speed is higher than in the low speed region and a high speed region in which the piston speed is higher than in the medium speed region.

### BRIEF DESCRIPTION OF THE DRAWINGS

FIG. 1 is a cross-sectional view showing a cylinder device according to a first embodiment of the present invention.

FIG. 2 is a cross-sectional view of a main part of the cylinder device according to the first embodiment of the present invention.

FIG. 3 is a one-side cross-sectional view showing the main part of the cylinder device according to the first embodiment of the present invention.

FIG. 4 is an exploded perspective view showing the main part of the cylinder device according to the first embodiment of the present invention.

FIG. 5 is a perspective view showing a slide valve of the cylinder device according to the first embodiment of the present invention.

FIG. 6 is a characteristic diagram showing a relationship between a piston speed and a damping force, which changes according to setting of a first stage valve of the cylinder device according to the first embodiment of the present invention.

FIG. 7 is a characteristic diagram showing the relationship between the piston speed and the damping force, which changes according to the setting of the first stage valve of the cylinder device according to the first embodiment of the present invention.

FIG. 8 is a characteristic diagram showing the relationship between the piston speed and the damping force, which changes according to setting of a second stage valve of the cylinder device according to the first embodiment of the present invention.

FIG. 9 is a cross-sectional view of a main part of a cylinder device according to a second embodiment of the present invention.

FIG. 10 is a one-side cross-sectional view showing the main part of the cylinder device according to the second embodiment of the present invention.

FIG. 11 is a plan view showing a support member of the cylinder device according to the second embodiment of the present invention.

FIG. 12 is a perspective view showing a slide valve of the cylinder device according to the second embodiment of the present invention.

FIG. 13 is a cross-sectional view of a main part of a cylinder device according to a third embodiment of the present invention.

FIG. 14 is a one-side cross-sectional view showing the main part of the cylinder device according to the third embodiment of the present invention.

FIG. 15 is an exploded perspective view showing the main part of the cylinder device according to the third embodiment of the present invention.

FIG. 16 is a perspective view showing a support member of the cylinder device according to the third embodiment of the present invention.

FIG. 17 is a perspective view showing a slide valve of the cylinder device according to the third embodiment of the present invention.

### DETAILED DESCRIPTION OF THE INVENTION

### First Embodiment

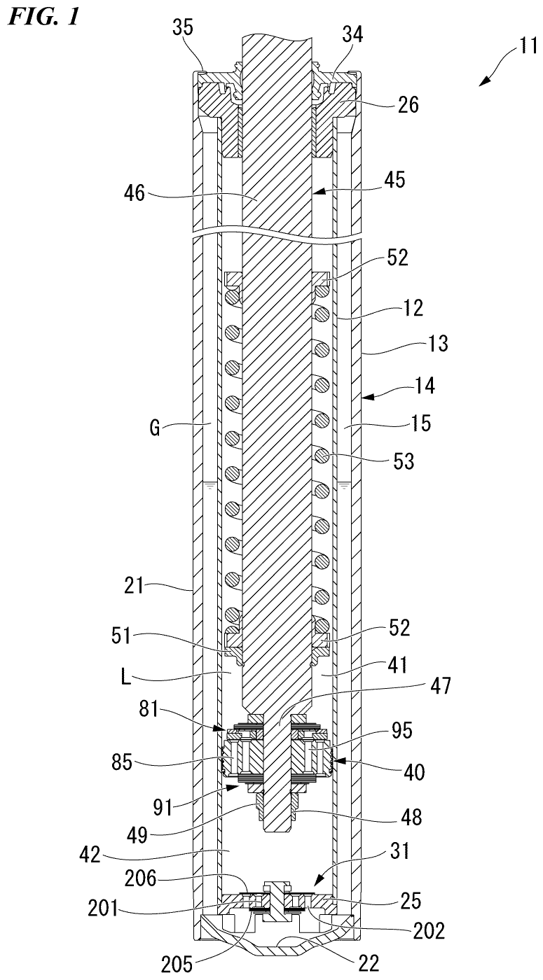

A cylinder device according to a first embodiment of the present invention will be described with reference to FIGS. 1 to 8. For ease of explanation, the upper side in FIGS. 1 to 3 and FIGS. 9, 10, 13 and 14 will be referred to as “upper,” and the lower side in FIGS. 1 to 3 and FIGS. 9, 10, 13 and 14 will be referred to as “lower”.

### <Configuration>

The cylinder device 11 of the first embodiment is a shock absorber used in suspension devices of railway vehicles and two-wheeled and four-wheeled automobiles, and more specifically, it is a shock absorber used in the suspension devices of four-wheeled automobiles. As shown in FIG. 1, the cylinder device 11 is a double tube type shock absorber equipped with a cylinder 14 having a cylindrical inner tube 12 and a cylindrical outer tube 13 with a bottom that has a larger diameter than the inner tube 12 and is provided outside the inner tube 12 in a radial direction. A reservoir chamber 15 is formed between the outer tube 13 and the inner tube 12.

The outer tube 13 has a cylindrical body portion 21 and a bottom portion 22 that closes a lower end portion which is one end portion of the body portion 21 in an axial direction. An upper end portion of the body portion 21 opposite to the bottom portion 22 is an opening portion.

The cylinder device 11 includes an annular valve body 25 provided at a lower end portion which is one end portion of the inner tube 12 in the axial direction, and an annular rod guide 26 provided at an upper end portion which is the other end portion of the inner tube 12 and the outer tube 13 in the axial direction. The valve body 25 constitutes a base valve 31, and has a stepped outer circumferential portion. The rod guide 26 also has a stepped outer circumferential portion, and a large diameter portion thereof is fitted into the body portion 21.

The inner tube 12 has a lower end portion, which is one end portion in the axial direction, fitted into a small diameter portion of the outer circumferential portion of the valve body 25, and engages with the bottom portion 22 of the outer tube 13 via the valve body 25. The inner tube 12 has an upper end portion, which is the other end portion in the axial direction, fitted into a small diameter portion of the outer circumferential portion of the rod guide 26, and engages with the body portion 21 of the outer tube 13 via the rod guide 26. In this state, the inner tube 12 is positioned in the radial direction so as to be coaxial with the outer tube 13. Here, a space between the valve body 25 and the bottom portion 22 communicates with a space between the inner tube 12 and the outer tube 13. Thus, the space between the valve body 25 and the bottom portion 22 constitutes a reservoir chamber 15, similar to the space between the inner tube 12 and the outer tube 13.

The cylinder device 11 has an annular seal member 34 on the side opposite to the bottom portion 22 of the rod guide 26. This seal member 34 is also fitted into the inner circumferential portion of the body portion 21 in the same manner as the rod guide 26. A locking portion 35 is formed at an end portion of the body portion 21 opposite to the bottom portion 22 by plastically deforming the body portion 21 inward in the radial direction by crimping, such as curling. The seal member 34 has a radially outer portion sandwiched between the locking portion 35 and the rod guide 26. The seal member 34 closes the opening portion of the outer tube 13, and is specifically an oil seal.

The cylinder device 11 has a piston 40 provided in the cylinder 14. The piston 40 is slidably provided in the inner tube 12 of the cylinder 14. The piston 40 divides the interior of the inner tube 12 into two chambers including an upper chamber 41 and a lower chamber 42. The upper chamber 41 is provided between the piston 40 in the inner tube 12 and the rod guide 26, and the lower chamber 42 is provided between the piston 40 in the inner tube 12 and the valve body 25. The lower chamber 42 is partitioned from the reservoir chamber 15 by the valve body 25. In the cylinder 14, the upper chamber 41 and the lower chamber 42 are filled with oil liquid L as a working fluid, and the reservoir chamber 15 is filled with gas G and oil liquid L as a working fluid.

The cylinder device 11 includes a piston rod 45 of which one side in the axial direction is disposed inside the cylinder 14 and connected to the piston 40 and the other side in the axial direction extends outside the cylinder 14. The piston rod 45 is made of a metal and passes through the upper chamber 41 but does not pass through the lower chamber 42. Thus, the upper chamber 41 is a rod side chamber through which the piston rod 45 passes, and the lower chamber 42 is a bottom side chamber on the bottom portion 22 side of the cylinder 14.

The piston 40 and the piston rod 45 move together. In an extension stroke of the cylinder device 11 in which an amount of protrusion of the piston rod 45 from the cylinder 14 is increased, the piston 40 moves toward the upper chamber 41, and in a compression stroke of the cylinder device 11 in which the amount of protrusion of the piston rod 45 from the cylinder 14 is reduced, the piston 40 moves toward the lower chamber 42.

Both of the rod guide 26 and the seal member 34 are annular, and the piston rod 45 is slidably inserted through the inside of each of the rod guide 26 and the seal member 34 and extends from the inside to the outside of the cylinder 14. One end portion of the piston rod 45 in the axial direction is disposed inside the cylinder 14 and is connected to the piston 40, and the other end portion in the axial direction extends outside the cylinder 14 via the rod guide 26 and the seal member 34.

The rod guide 26 supports the piston rod 45 so as to be movable in the axial direction while restricting the piston rod 45 moving in the radial direction with respect to the cylinder 14, thereby guiding movement of the piston rod 45.

An outer circumferential portion of the seal member 34 is in close contact with the outer tube 13 of the cylinder 14, and an inner circumferential portion thereof is in sliding contact with an outer circumferential portion of the piston rod 45 which moves in the axial direction. Thus, the seal member 34 allows the piston rod 45 to slide while the oil liquid L and gas G in the cylinder 14 is prevented from leaking to the outside.

The piston rod 45 has a cylindrical main shaft portion 46 and a cylindrical mounting shaft portion 47 that is coaxial with the main shaft portion 46 and has an outer diameter smaller than that of the main shaft portion 46. The main shaft portion 46 of the piston rod 45 is slidably fitted in the rod guide 26 and the seal member 34 and extends outside the cylinder 14. The mounting shaft portion 47 of the piston rod 45 is disposed within the cylinder 14 and is connected to the piston 40 and the like. An end portion of the main shaft portion 46 on the side of the mounting shaft portion 47 is wider in a direction perpendicular to an axis. A male thread 48 is formed on an outer circumferential portion of the mounting shaft portion 47 at a tip end position on the side opposite to the main shaft portion 46. The cylinder device 11 has a nut 49 that is screwed onto the male thread 48 to mount the piston 40 and the like on the piston rod 45.

The cylinder device 11 includes a stopper member 51, a pair of buffer bodies 52, and a coil spring 53. The stopper member 51, the pair of buffer bodies 52, and the coil spring 53 are all annular. The stopper member 51, the pair of buffer bodies 52 and the coil spring 53 are all provided on a portion of the main shaft portion 46 closer to the mounting shaft portion 47 than the rod guide 26 in the axial direction. The inner circumferential side of the stopper member 51 is fixed to the main shaft portion 46. On the side of the rod guide 26 with respect to the stopper member 51, one buffer body 52, the coil spring 53 and the other buffer body 52 are disposed in this order from the side of the stopper member 51. The piston rod 45 is inserted through the pair of buffer bodies 52 and the coil spring 53 on their respective inner circumference sides. The stopper member 51, the pair of buffer bodies 52 and the coil spring 53 come into contact with the rod guide 26 at the upper buffer body 52, the coil spring 53 is compressed and deformed, and thus an impact when the piston rod 45 fully extends is absorbed.

When the cylinder device 11 is mounted in a vehicle, for example, the portion of the piston rod 45 that protrudes from the cylinder 14 is disposed at an upper portion and is supported by a vehicle body, and the side of the bottom portion 22 of the cylinder 14 is disposed at a lower portion and is connected to the wheel side. In the case of a single tube type cylinder device, the cylinder side may be supported by the vehicle body, and the piston rod may be connected to the wheel side.

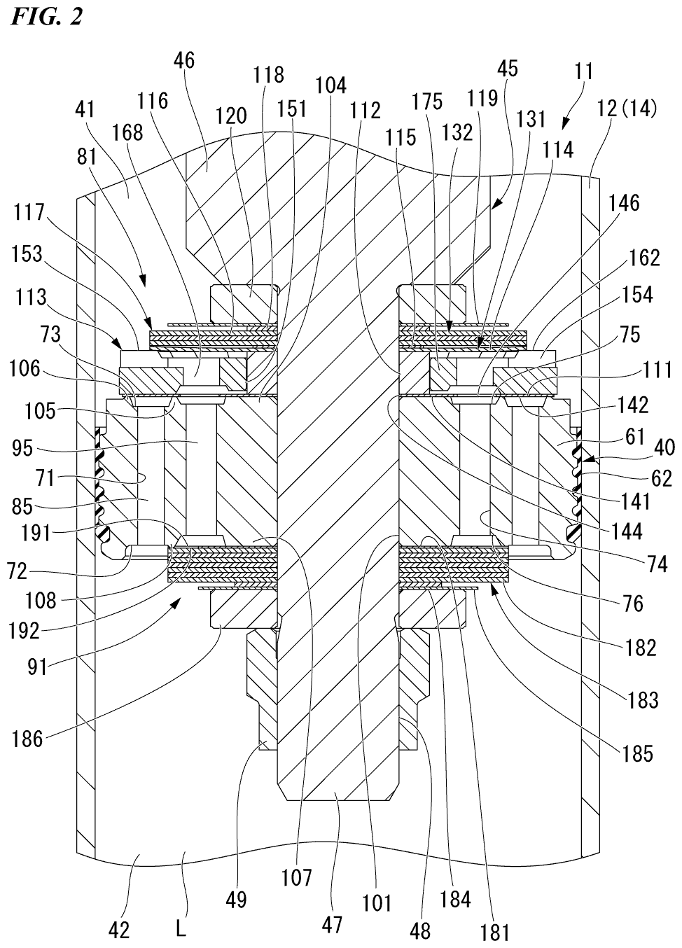

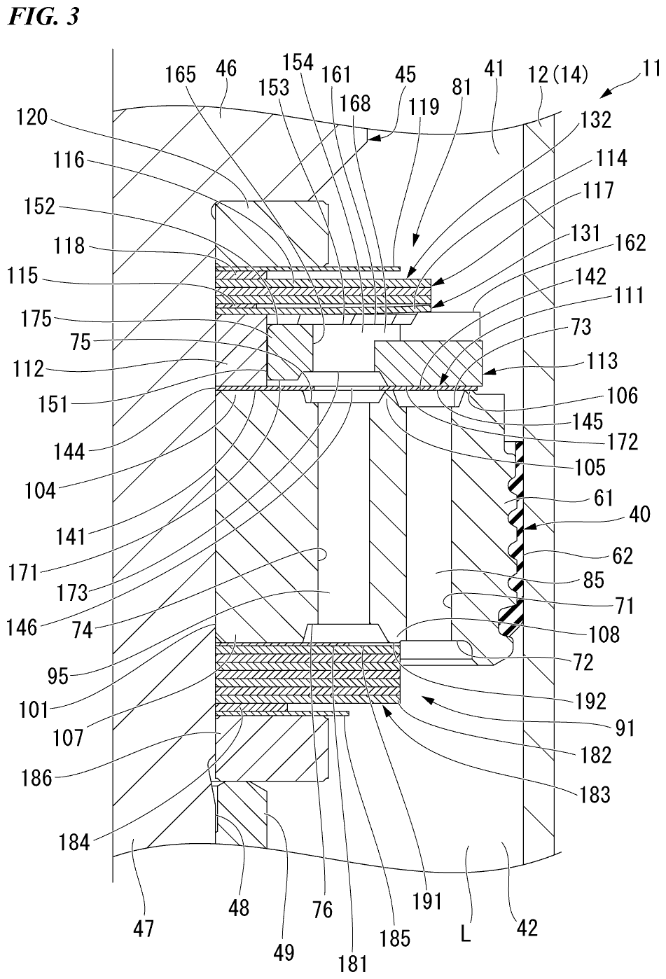

As shown in FIGS. 2 to 4, the piston 40 has a piston body 61 and a sliding member 62. The piston body 61 has an annular shape and is made of a metal. As shown in FIGS. 2 and 3, the piston body 61 is fitted onto the mounting shaft portion 47 of the piston rod 45. The sliding member 62 has an annular shape and is made of a synthetic resin. The sliding member 62 is mounted on an outer circumferential surface of the piston body 61 so as to be integrated with the piston body 61. The sliding member 62 of the piston 40 is in contact with the inner tube 12 and slides inside the inner tube 12. An axial direction of the piston body 61 is the axial direction of the piston 40, a radial direction of the piston body 61 is the radial direction of the piston 40, and a circumferential direction of the piston body 61 is the circumferential direction of the piston 40.

The piston body 61 has a plurality of passage holes 71, an annular concave portion 72, an annular concave portion 73, a plurality of passage holes 74, an annular concave portion 75, and an annular concave portion 76.

The plurality of passage holes 71 are disposed at equal pitches in the circumferential direction of the piston body 61 at positions equidistant from a central axis of the piston body 61. All of the plurality of passage holes 71 form straight lines in the axial direction of the piston body 61.

The annular concave portion 72 is provided at an end portion of the piston body 61 on the side of the lower chamber 42. The annular concave portion 72 has an annular shape centered on the central axis of the piston body 61. The annular concave portion 72 causes opening portions of the plurality of passage holes 71 on the side of the lower chamber 42 to be communicating with each other.

The annular concave portion 73 is provided at an end portion of the piston body 61 on the side of the upper chamber 41. The annular concave portion 73 has an annular shape centered on the central axis of the piston body 61. The annular concave portion 73 causes the opening portions of the plurality of passage holes 71 on the side of the upper chamber 41 to be communicating with each other.

The plurality of passage holes 71, the annular concave portion 72 and the annular concave portion 73 allow the lower chamber 42 and the upper chamber 41 to be communicating with each other.

The plurality of passage holes 74 are disposed at equal pitches in the circumferential direction of the piston body 61 at positions equidistant from the central axis of the piston body 61. All of the plurality of passage holes 74 form straight lines in the axial direction of the piston body 61. A distance of the plurality of passage holes 74 from the central axis of the piston body 61 is shorter than a distance of the plurality of passage holes 71 from the central axis of the piston body 61. Therefore, the plurality of passage holes 71 are disposed in the piston body 61 so as to surround the plurality of passage holes 74 outward of the piston body 61 in the radial direction.

The annular concave portion 75 is provided at an end portion of the piston body 61 on the side of the upper chamber 41. The annular concave portion 75 has an annular shape centered on the central axis of the piston body 61. The annular concave portion 75 allows the opening portions of the plurality of passage holes 74 on the side of the upper chamber 41 to be communicating with each other. The annular concave portion 75 is disposed inward of the piston body 61 in the radial direction with respect to the annular concave portion 73. Thus, the annular concave portion 73 is provided coaxially with the annular concave portion 75 to surround the annular concave portion 75 outward in the radial direction. The annular concave portion 75 overlaps the annular concave portion 73 in the axial direction of the piston body 61.

The annular concave portion 76 is provided at an end portion of the piston body 61 on the side of the lower chamber 42. The annular concave portion 76 has an annular shape centered on the central axis of the piston body 61. The annular concave portion 76 communicates the opening portions of the plurality of passage holes 74 on the side of the lower chamber 42 with each other. The annular concave portion 76 is disposed inward of the piston body 61 in the radial direction with respect to the annular concave portion 72. Thus, the annular concave portion 72 is provided coaxially with the annular concave portion 76 to surround the annular concave portion 76 outward in the radial direction. The annular concave portion 76 is located inward with respect to the annular concave portion 72 in the axial direction of the piston body 61.

The plurality of passage holes 74, the annular concave portion 75, and the annular concave portion 76 can communicate the upper chamber 41 and the lower chamber 42 with each other.

A damping force generating mechanism 81 is provided for the plurality of passage holes 71 and the annular concave portions 72 and 73. The damping force generating mechanism 81 opens and closes passages within the plurality of passage holes 71 and passages within the annular concave portions 72 and 73 to generate a damping force. The damping force generating mechanism 81 is mounted on the piston rod 45. The damping force generating mechanism 81 is disposed on the side of the upper chamber 41 which is one end side of the piston 40 in the axial direction. Thus, the passages within the plurality of passage holes 71 and the passages within the annular concave portions 72 and 73 become a first passage 85 through which the oil liquid L flows from the lower chamber 42 toward the upper chamber 41 as the piston 40 moves toward the lower chamber 42. The first passage 85 is a compression-side passage through which the oil liquid L flows from the lower chamber 42 toward the upper chamber 41 in the compression stroke of the piston rod 45. The damping force generating mechanism 81 provided in the first passage 85 is a compression-side damping force generating mechanism that generates a damping force by controlling a flow of the oil liquid L in the first passage 85.

A damping force generating mechanism 91 is provided for the plurality of passage holes 74 and the annular concave portions 75 and 76. The damping force generating mechanism 91 opens and closes passages within the plurality of passage holes 74 and passages within the annular concave portions 75 and 76 to generate a damping force. The damping force generating mechanism 91 is mounted on the piston rod 45. The damping force generating mechanism 91 is disposed on the other end side of the piston 40 opposite to the damping force generating mechanism 81 provided on one end side of the piston 40 in the axial direction, that is, on the side of the lower chamber 42. Thus, the passages within the plurality of passage holes 74 and the passages within the annular concave portions 75 and 76 become a second passage 95 through which the oil liquid L flows from the upper chamber 41 toward the lower chamber 42 as the piston 40 moves toward the upper chamber 41. The second passage 95 is an extension-side passage through which the oil liquid L flows from the upper chamber 41 toward the lower chamber 42 in the extension stroke of the piston rod 45. The damping force generating mechanism 91 provided in the second passage 95 is an extension-side damping force generating mechanism that generates a damping force by controlling the flow of the oil liquid L in the passage inside the second passage 95. The damping force generating mechanism 81 may be used as the extension-side damping force generating mechanism instead of the damping force generating mechanism 91. In that case, the compression-side damping force generating mechanism becomes the damping force generating mechanism 91.

As a result of the above, the first passage 85 and the second passage 95 communicate the upper chamber 41 and the lower chamber 42 with each other so that the oil liquid L can flow therebetween as the piston 40 moves. The oil liquid L passes through the first passage 85 when the piston rod 45 and the piston 40 move toward the compression side. The oil liquid L passes through the second passage 95 when the piston rod 45 and the piston 40 move toward the extension side.

The piston body 61 has a generally circular disc shape. A fitting hole 101 is formed in the piston body 61. The fitting hole 101 is formed in the center of the piston body 61 in the radial direction. The fitting hole 101 passes through the piston body 61 in the axial direction of the piston body 61. The mounting shaft portion 47 of the piston rod 45 is fitted into the fitting hole 101. As a result, the piston body 61 and the piston 40 including the piston body 61 are positioned in the radial direction with respect to the mounting shaft portion 47 of the piston rod 45.

The piston body 61 has an inner seat portion 104, an inner valve seat portion 105, an outer valve seat portion 106, an inner seat portion 107, and a valve seat portion 108.

The inner seat portion 104, the inner valve seat portion 105 and the outer valve seat portion 106 are all provided at the end portion of the piston body 61 on the side of the upper chamber 41 in the axial direction.

The inner seat portion 104 is disposed between the fitting hole 101 of the piston body 61 and the annular concave portion 75. The inner seat portion 104 has an annular shape.

The inner valve seat portion 105 is disposed between the annular concave portion 75 and the annular concave portion 73. The inner valve seat portion 105 has an annular shape, has a larger diameter than the inner seat portion 104 and is disposed coaxially with the inner seat portion 104.

The outer valve seat portion 106 is disposed outward of the annular concave portion 73 of the piston body 61 in the radial direction. The outer valve seat portion 106 has an annular shape, has a larger diameter than the inner valve seat portion 105 and is disposed coaxially with the inner valve seat portion 105.

The inner seat portion 104, the inner valve seat portion 105 and the outer valve seat portion 106 align a position of an outer end surface of the piston body 61 in the axial direction. The piston body 61 has the annular concave portion 75 between the inner seat portion 104 and the inner valve seat portion 105, and has the annular concave portion 73 between the inner valve seat portion 105 and the outer valve seat portion 106.

The inner seat portion 107 and the valve seat portion 108 are both provided at the end portion of the piston body 61 on the side of the lower chamber 42 in the axial direction.

The inner seat portion 107 is disposed between the fitting hole 101 of the piston body 61 and the annular concave portion 76. The inner seat portion 107 has an annular shape.

The valve seat portion 108 is disposed between the annular concave portion 76 and the annular concave portion 72. The valve seat portion 108 has an annular shape, has a larger diameter than the inner seat portion 107 and is disposed coaxially with the inner seat portion 107.

An outer end surface of the valve seat portion 108 in the axial direction of the piston body 61 is located slightly outward in the axial direction of the piston body 61 of an outer end surface of the inner seat portion 107 in the axial direction of the piston body 61. In other words, the valve seat portion 108 protrudes slightly outward of the inner seat portion 107 in the axial direction of the piston body 61. The piston body 61 has the annular concave portion 76 between the inner seat portion 107 and the valve seat portion 108.

In the piston body 61, the compression-side first passage 85 is disposed outward of the inner valve seat portion 105 and the valve seat portion 108 in the radial direction. In the piston body 61, the extension-side second passage 95 is disposed inward of the inner valve seat portion 105 and the valve seat portion 108 in the radial direction.

The piston 40 is fitted onto the mounting shaft portion 47 in a state in which the inner seat portion 104, the inner valve seat portion 105 and the outer valve seat portion 106 face toward the main shaft portion 46 in the axial direction. The inner valve seat portion 105 and the outer valve seat portion 106 of the piston 40 constitute a part of the damping force generating mechanism 81. The valve seat portion 108 of the piston 40 constitutes a part of the damping force generating mechanism 91.

In a state in which the mounting shaft portion 47 is inserted inward in the radial direction between the main shaft portion 46 and the piston 40, an intake valve 111 (a first valve), one spacer 112 and one slide valve 113 (a second valve), one valve disc 114, one retainer 115, a valve member 117 including a plurality of discs 116, one retainer 118, one backup disc 119 and one washer 120 are provided on the mounting shaft portion 47 of the piston rod 45 in this order from the side of the piston 40. The valve disc 114 and the retainer 115 constitute a first stage valve 131 (a third valve). The valve member 117 and the retainer 118 constitute a second stage valve 132 (a fourth valve).

The intake valve 111, the spacer 112, the valve disc 114, the retainer 115, the valve member 117, the retainer 118, the backup disc 119 and the washer 120 are positioned in the radial direction with respect to the mounting shaft portion 47 by inserting the mounting shaft portion 47 inward in the radial direction. In addition, at least inner circumferential sides of the intake valve 111, the spacer 112, the valve disc 114, the retainer 115, the valve member 117, the retainer 118, the backup disc 119 and the washer 120 are sandwiched between the main shaft portion 46 of the piston rod 45 and the inner seat portion 104 of the piston 40 in a state in which they are pressurized in the axial direction, and thus at least the inner circumferential sides are fixed to the mounting shaft portion 47 of the piston rod 45.

The intake valve 111, the spacer 112, the one slide valve 113, the valve disc 114, the retainer 115, the valve member 117 including the plurality of discs 116, the retainer 118, the backup disc 119 and the washer 120 constitute the damping force generating mechanism 81. A shape of a contact surface of the slide valve 113 is not limited as long as it is a shape suitable for applying a set load to the intake valve 111 at a contact surface between the intake valve 111 and the slide valve 113. For example, a cross-sectional shape of the slide valve 113 in a plane including the central axis may be flat, or may be convex toward the intake valve 111. When the cross-sectional shape is convex, a position of the convexity with respect to the intake valve 111 can be set arbitrarily.

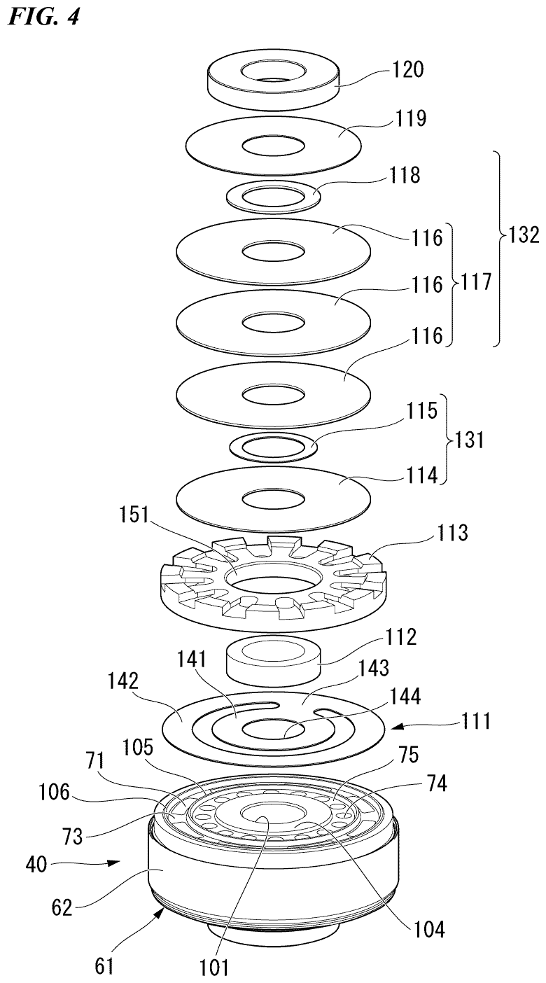

The intake valve 111 is made of a metal and has a circular flat plate shape with a hole, as shown in FIG. 4. The intake valve 111 is formed by press molding from a single flat plate material. The intake valve 111 has a first annular portion 141, a second annular portion 142, and a connection portion 143.

The first annular portion 141 has an annular shape with a constant width in the radial direction.

The second annular portion 142 has an annular shape with a constant width in the radial direction. The second annular portion 142 has an inner diameter larger than an outer diameter of the first annular portion 141 and is disposed so as to surround the first annular portion 141 outward of the first annular portion 141 in the radial direction.

The connection portion 143 connects a part of an outer circumferential edge of the first annular portion 141 to a part of the inner circumferential edge of the second annular portion 142 that is aligned with the part of the outer circumferential edge in the circumferential direction. The connection portion 143 connects the first annular portion 141 and the second annular portion 142 so as to be coaxially disposed. The connection portion 143 extends in a radial direction of the first annular portion 141 and the second annular portion 142 and connects the first annular portion 141 and the second annular portion 142 in the radial direction.

The first annular portion 141 has an insertion hole 144 formed on the inner side thereof in the radial direction, and as shown in FIGS. 2 and 3, the mounting shaft portion 47 of the piston rod 45 is inserted through the insertion hole 144. Thus, the first annular portion 141 of the intake valve 111 is positioned in the radial direction with respect to the mounting shaft portion 47 of the piston rod 45, and the entire intake valve 111 is positioned in the radial direction with respect to the mounting shaft portion 47 of the piston rod 45. The first annular portion 141 of the intake valve 111 is fixed to the mounting shaft portion 47 of the piston rod 45.

In the intake valve 111, an outer diameter of the second annular portion 142 is larger than an outer diameter of the outer valve seat portion 106, and an inner diameter of the second annular portion 142 is smaller than an inner diameter of the inner valve seat portion 105. In the intake valve 111, an outer diameter of the first annular portion 141 is larger than an outer diameter of the inner seat portion 104 of the piston 40. The intake valve 111 is in contact with the inner seat portion 104 at the first annular portion 141 in the axial direction.

In the intake valve 111, when the second annular portion 142 comes into contact with both the outer valve seat portion 106 and the inner valve seat portion 105 over the entire circumference, a blocking portion 145 shown in FIG. 3 between a portion in contact with the outer valve seat portion 106 and a portion in contact with the inner valve seat portion 105 blocks the opening of the first passage 85 on the side of the upper chamber 41, and thus blocks communication between the first passage 85 and the upper chamber 41. When the second annular portion 142 moves away from the outer valve seat portion 106, the intake valve 111 communicates the first passage 85 with the upper chamber 41 via a passage between the second annular portion 142 and the outer valve seat portion 106. When the second annular portion 142 moves away from the inner valve seat portion 105, the intake valve 111 communicates the first passage 85 to a position inward of the inner valve seat portion 105 in the radial direction via a passage between the second annular portion 142 and the inner valve seat portion 105. The intake valve 111 has the blocking portion 145 that blocks the first passage 85. In the intake valve 111, a gap between the second annular portion 142 and the first annular portion 141 forms an intake valve passage 146 that is constantly communicated with the second passage 95.

The spacer 112 is made of a metal and has a cylindrical shape. The mounting shaft portion 47 of the piston rod 45 is inserted through the inner side of the spacer 112 in the radial direction. The spacer 112 has an outer diameter smaller than the outer diameter of the first annular portion 141 of the intake valve 111 and smaller than the outer diameter of the inner seat portion 104 of the piston body 61. The spacer 112 is in contact with the first annular portion 141.

The slide valve 113 is made of a metal and has a disc shape with a hole. The slide valve 113 is formed by sintering or cutting.

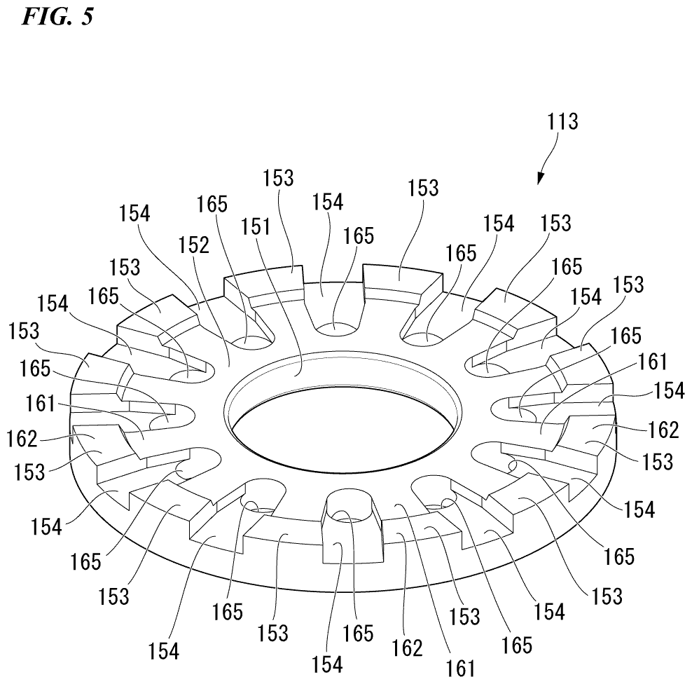

As shown in FIG. 5, the slide valve 113 has a through hole 151 formed in the center thereof in the radial direction so as to pass through the slide valve 113 in the axial direction. The slide valve 113 has an inner annular portion 152, a radial extension portion 153, and a radial groove portion 154 formed on one side thereof in the axial direction.

The inner annular portion 152 has an annular shape and has the through hole 151 formed on the inner side thereof in the radial direction.

The radial extension portion 153 extends radially outward of the slide valve 113 from a radial outer end portion of the inner annular portion 152 in the radial direction of the slide valve 113. The radial extension portion 153 has an extension main body portion 161 that extends from the inner annular portion 152 to the radial outer end of the slide valve 113, and a convex portion 162 provided on an outer portion of the extension main body portion 161 in the radial direction of the slide valve 113.

The extension main body portion 161 has a height in the axial direction of the slide valve 113 equal to that of the inner annular portion 152. Outer end surfaces of the inner annular portion 152 and the extension main body portion 161 in the axial direction of the slide valve 113 are flush with each other.

A height of the convex portion 162 in the axial direction of the slide valve 113 is higher than the inner annular portion 152 and the extension main body portion 161. Therefore, the convex portion 162 protrudes outward in the axial direction of the slide valve 113 from the outer portion of the extension main body portion 161 in the radial direction of the slide valve 113.

A plurality of radial extension portions 153 having the same shape which are radially provided at equal intervals in the circumferential direction of the slide valve 113 are provided on the slide valve 113. Therefore, a plurality of convex portions 162 having the same shape are provided on the slide valve 113 at equal intervals in the circumferential direction of the slide valve 113. In outer tip end surfaces of the plurality of convex portions 162 in the axial direction of the slide valve 113, inner edge portions in the radial direction of the slide valve 113 are disposed on the same circle centered on the central axis of the slide valve 113.

In the slide valve 113, the radial groove portion 154 which is recessed inward in the axial direction of the slide valve 113 further than the inner annular portion 152 and the radial extension portions 153 is formed between the radial extension portions 153 adjacent to each other in the circumferential direction of the slide valve 113. The radial groove portion 154 extends from the outer end portion of the inner annular portion 152 in the radial direction of the slide valve 113 to the outer end of the slide valve 113 in the radial direction, and exits outward in the radial direction of the slide valve 113. In the slide valve 113, the radial groove portions 154 having the same shape are formed between all of the radial extension portions 153 adjacent to each other in the circumferential direction of the slide valve 113. Therefore, a plurality of radial groove portions 154 having the same shape, the number of which is the same as the number of radial extension portions 153, are provided at equal intervals in the circumferential direction of the slide valve 113 in the slide valve 113.

In the slide valve 113, a passage hole 165 that passes through the slide valve 113 in the axial direction of the slide valve 113 is formed at an end portion of the radial groove portion 154 on the side of the inner annular portion 152 in the radial direction of the slide valve 113. Therefore, the passage hole 165 opens to a bottom surface of the radial groove portion 154. In the slide valve 113, the passage holes 165 having the same shape are formed in the end portions of all the radial groove portions 154 on the side of the inner annular portion 152.

As shown in FIG. 3, in the slide valve 113, an inner annular portion 171, an outer annular portion 172, and a circumferential groove portion 173 are formed on the side opposite to the inner annular portion 152, the radial extension portion 153, and the radial groove portion 154 in the axial direction.

The inner annular portion 171 has an annular shape and has a through hole 151 formed on the inner side thereof in the radial direction.

The outer annular portion 172 has an annular shape, is coaxial with the inner annular portion 171, and has an inner diameter larger than an outer diameter of the inner annular portion 171. The outer annular portion 172 extends to the outer end of the slide valve 113 in the radial direction. The outer annular portion 172 has a height in the axial direction of the slide valve 113 that is higher than that of the inner annular portion 171. In other words, the outer annular portion 172 protrudes outward in the axial direction of the slide valve 113 more than the inner annular portion 171.

In the slide valve 113, a circumferential groove portion 173 which is recessed inward in the axial direction of the slide valve 113 more than the inner annular portion 171 and the outer annular portion 172 is formed between the inner annular portion 171 and the outer annular portion 172 adjacent to each other in the radial direction of the slide valve 113. The circumferential groove portion 173 has an annular shape that is coaxial with the inner annular portion 171 and the outer annular portion 172. All of the plurality of passage holes 165 open to a bottom surface of the circumferential groove portion 173.

The slide valve 113 is slidably fitted to the outer circumferential portion of the spacer 112 in the through hole 151. Thus, the slide valve 113 is positioned in the radial direction with respect to the mounting shaft portion 47 of the piston rod 45 via the spacer 112. The slide valve 113 is oriented such that the inner annular portion 171, the outer annular portion 172 and the circumferential groove portion 173 face the intake valve 111 in the axial direction.

The outer annular portion 172 of the slide valve 113 is capable of coming into contact with the second annular portion 142 of the intake valve 111 in the axial direction. An inner diameter of a tip end surface of the outer annular portion 172 that comes into contact with the second annular portion 142 is smaller than an outer diameter of a tip end surface that comes into contact with the second annular portion 142 of the inner valve seat portion 105, and is larger than an inner diameter of this tip end surface. An outer diameter of the tip end surface of the outer annular portion 172 that comes into contact with the second annular portion 142 is larger than an outer diameter of a tip end surface that comes into contact with the second annular portion 142 of the outer valve seat portion 106, and is larger than an outer diameter of the second annular portion 142.

In the slide valve 113, an axial length of an inner circumferential structural portion 175 including both the inner annular portion 152 and the inner annular portion 171, that is, an axial distance between facing end surfaces of the inner annular portion 152 and the inner annular portion 171, is shorter than an axial thickness of the spacer 112.

In the slide valve 113, an axial distance between facing end surfaces of the plurality of convex portions 162 and the outer annular portion 172 is slightly longer than the axial thickness of the spacer 112. In the slide valve 113, the inner sides of the plurality of passage holes 165 and the plurality of radial groove portions 154 form a third passage 168. The third passage 168 communicates with the second passage 95 via the intake valve passage 146 of the intake valve 111. When the second annular portion 142 of the intake valve 111 moves away from the inner valve seat portion 105 of the piston 40, the third passage 168 communicates with the first passage 85 and allows the oil liquid L flowing out of the first passage 85 to flow therethrough.

The valve disc 114 constituting the first stage valve 131 is made of a metal, and has a circular flat plate shape with a hole before being assembled to the piston rod 45. The valve disc 114 is formed by press molding from a single flat plate material. A radial width of the valve disc 114 is constant over the entire circumference. The mounting shaft portion 47 of the piston rod 45 is inserted through the inner side of the valve disc 114 in the radial direction.

As described above, in the outer tip end surfaces of the plurality of convex portions 162 of the slide valve 113 in the axial direction of the slide valve 113, the inner edge portions in the radial direction of the slide valve 113 are disposed on the same circle, but an outer diameter of the valve disc 114 is larger than a diameter of this circle. In addition, the axial thickness of the spacer 112 is slightly thinner than an axial thickness at positions of the plurality of convex portions 162 of the slide valve 113, that is, a distance between the end surfaces of the convex portions 162 and the outer annular portion 172 that face each other in the axial direction of the slide valve 113. Therefore, even in a state in which the slide valve 113 is in contact with the second annular portion 142 of the intake valve 111 at the outer annular portion 172, and the second annular portion 142 is in contact with the inner valve seat portion 105 and the outer valve seat portion 106 of the piston 40, the valve disc 114 is in contact with the plurality of convex portions 162 of the slide valve 113, and the outer circumferential side thereof is bent so as to move away from the piston 40 in the axial direction as it goes outward in the radial direction. At this time, the plurality of convex portions 162 are disposed at intervals in the circumferential direction on the side of the slide valve 113 opposite to the valve disc 114. Therefore, in a state in which the valve disc 114 is in contact with the plurality of convex portions 162 of the slide valve 113, a portion of the valve disc 114 that is not in contact with the plurality of convex portions 162 deforms so as to enter slightly into the radial groove portion 154 in the axial direction. Therefore, when the valve disc 114 comes into contact with the slide valve 113, the plurality of convex portions 162 cause the valve disc 114 to corrugate in the circumferential direction.

In a state in which the outer circumferential side of the valve disc 114 is in contact with the plurality of convex portions 162 of the slide valve 113, the valve disc 114 blocks the third passage 168 of the slide valve 113 maximally, thereby minimizing an amount of communication between the third passage 168 and the upper chamber 41. When the outer circumference of the valve disc 114 bends and moves away in the axial direction from the plurality of convex portions 162 of the slide valve 113, the valve disc 114 opens the third passage 168 and increases the amount of communication between the third passage 168 and the upper chamber 41. In this way, the valve disc 114 is capable of opening and closing the third passage 168. The valve disc 114 can bias the intake valve 111 via the slide valve 113 and can adjust a biasing force of the intake valve 111.

The retainer 115 constituting the first stage valve 131 is made of a metal and has a circular plate shape with a hole. The retainer 115 is formed by press molding from a single flat plate material. The retainer 115 has a constant radial width over the entire circumference. The mounting shaft portion 47 of the piston rod 45 is inserted through the inner side of the retainer 115 in the radial direction. The retainer 115 has an outer diameter smaller than an outer diameter of the valve disc 114 and smaller than an outer diameter of the spacer 112.

The plurality of discs 116 of the valve member 117 constituting the second stage valve 132 are made of a metal and have the same shape. The discs 116 have a circular flat plate shape with a hole. The discs 116 are formed by press molding from a single flat plate material. The discs 116 have a constant radial width over the entire circumference. The mounting shaft portion 47 of the piston rod 45 is inserted through the inner sides of the discs 116 in the radial direction. An outer diameter of each of the discs 116 is larger than an outer diameter of the retainer 115 and is equal to the outer diameter of the intake valve 111. The valve member 117 is formed by stacking the plurality of discs 116 in the axial direction. The valve member 117 is capable of coming into contact with the valve disc 114, and the outer circumference thereof is bent to control an amount of movement of the valve disc 114, in other words, an amount of valve opening.

The retainer 118 constituting the second stage valve 132 is made of a metal and has a circular plate shape with a hole. The retainer 118 is formed by press molding from a single flat plate material. The retainer 118 has a constant radial width over the entire circumference. The mounting shaft portion 47 of the piston rod 45 is inserted through the inner side of the retainer 118 in the radial direction. The retainer 118 has an outer diameter smaller than the outer diameter of the valve member 117 and equal to the outer diameter of the spacer 112.

The backup disc 119 is made of a metal and has a circular flat plate shape with a hole. The backup disc 119 is formed by press molding from a single flat plate material. A radial width of the backup disc 119 is constant over the entire circumference. The mounting shaft portion 47 of the piston rod 45 is inserted through the inner side of the backup disc 119 in the radial direction. The backup disc 119 has an outer diameter larger than the outer diameter of the retainer 118 and smaller than the outer diameter of the valve member 117.

The washer 120 is made of a metal and has an annular shape with a hole. The washer 120 is formed from a single member by cutting or the like. A radial width of the washer 120 is constant over the entire circumference. The mounting shaft portion 47 of the piston rod 45 is inserted through the inner side of the washer 120 in the radial direction. An outer diameter of the washer 120 is smaller than the outer diameter of the backup disc 119. The washer 120 is thicker and more rigid than the backup disc 119, the disc 116 constituting the valve member 117, and the intake valve 111. The washer 120, together with the backup disc 119, comes into contact with the valve member 117 so as to curb the valve member 117 being deformed beyond a predetermined amount. In the outer tip end surfaces of the plurality of convex portions 162 in the axial direction of the slide valve 113, a diameter of the same circle on which the inner edge portions in the radial direction of the slide valve 113 are disposed is larger than the outer diameter of the washer 120.

In a state in which the mounting shaft portion 47 is inserted inward in the radial direction on the side opposite to the main shaft portion 46 in the axial direction of the piston 40, a valve member 183 including one orifice disc 181 and a plurality of discs 182, one retainer 184, one backup disc 185, and one washer 186 are provided in this order from the side of the piston 40 at the mounting shaft portion 47 of the piston rod 45. In the valve member 183, the orifice disc 181 is provided closest to the piston 40.

By inserting the mounting shaft portion 47 inward in the radial direction, the orifice disc 181, the plurality of discs 182, the retainer 184, the backup disc 185, and the washer 186 are positioned in the radial direction with respect to the mounting shaft portion 47 of the piston rod 45. At least the inner circumferential sides of the valve member 183, the retainer 184, the backup disc 185, and the washer 186 are sandwiched between the inner seat portion 107 of the piston 40 and the nut 49 in a state in which they are pressurized in the axial direction, and thus at least the inner circumferential sides are fixed to the piston rod 45. The valve member 183, the retainer 184, the backup disc 185, and the washer 186 constitute the damping force generating mechanism 91.

The orifice disc 181 is made of a metal and has a circular flat plate shape with a hole. The orifice disc 181 is formed by press molding from a single flat plate material. The orifice disc 181 has a cutout portion 191 that is formed in an outer circumferential portion thereof and extends outward in the radial direction. The orifice disc 181 has an annular shape with a constant radial width except for the cutout portion 191. The mounting shaft portion 47 of the piston rod 45 is inserted through an inner circumferential side of the orifice disc 181.

The orifice disc 181 has an outer diameter larger than an outer diameter of the valve seat portion 108 except for the cutout portion 191. The orifice disc 181 is provided such that the cutout portion 191 traverses the valve seat portion 108 in the radial direction. When the orifice disc 181 comes into contact with the valve seat portion 108, the orifice disc 181 blocksan opening of the second passage 95 on the side of the lower chamber 42, thereby restricting communication between the second passage 95 and the lower chamber 42. The cutout portion 191 constitutes an orifice 192 that communicates between the second passage 95 and the lower chamber 42 even when the orifice disc 181 comes into contact with the valve seat portion 108 and restricts communication between the second passage 95 and the lower chamber 42.

The plurality of discs 182 constituting the valve member 183 together with the orifice disc 181 have the same shape. The discs 182 are made of a metal and have a circular flat plate shape with a hole. The discs 182 are formed by press molding from a single flat plate material. A radial width of each of the discs 182 is constant over the entire circumference. The mounting shaft portion 47 of the piston rod 45 is inserted through the inner sides of the discs 182 in the radial direction. An outer diameter of each of the discs 182 is equal to an outer diameter of the orifice disc 181 except for the cutout portion 191. The valve member 183 is configured by stacking the orifice disc 181 and the plurality of discs 182 in the axial direction. The valve member 183 opens and closes the second passage 95.

The retainer 184 is made of a metal and has a circular flat plate shape with a hole. The retainer 184 is formed by press molding from a single flat plate material. A radial width of the retainer 184 is constant over the entire circumference. The mounting shaft portion 47 of the piston rod 45 is inserted through the inner side of the retainer 184 in the radial direction. An outer diameter of the retainer 184 is smaller than an outer diameter of the valve member 183 and is smaller than the outer diameter of the inner seat portion 107.

The backup disc 185 is made of a metal and has a circular flat plate shape with a hole. The backup disc 185 is formed by press molding from a single flat plate material. A radial width of the backup disc 185 is constant over the entire circumference. The mounting shaft portion 47 of the piston rod 45 is inserted through the inner side of the backup disc 185 in the radial direction. The backup disc 185 has an outer diameter larger than the outer diameter of the retainer 184 and smaller than the outer diameter of the valve member 183.

The washer 186 is made of a metal and has a circular shape with a hole. The washer 186 is formed from a single member by cutting or the like. A radial width of the washer 186 is constant over the entire circumference. The mounting shaft portion 47 of the piston rod 45 is inserted through the inner side of the washer 186 in the radial direction. An outer diameter of the washer 186 is smaller than the outer diameter of the backup disc 185. The washer 186 is thicker and more rigid than the backup disc 185 and the orifice disc 181 and the disc 182 that constitute the valve member 183. The washer 186, together with the backup disc 185, comes into contact with the valve member 183 to curb the valve member 183 being deformed beyond a predetermined amount.

An axial length of the inner circumferential structural portion 175 of the slide valve 113 on the inner side in the radial direction is shorter than that of the spacer 112 disposed inside the inner circumferential structural portion 175, and the entire slide valve 113 is capable of moving in the axial direction with respect to the spacer 112, that is, with respect to the piston rod 45 to which the spacer 112 is fixed. In other words, both the inner circumference and the outer circumference of the slide valve 113 are capable of moving in the axial direction with respect to the spacer 112 and the piston rod 45.

When a pressure difference between the upper chamber 41 and the lower chamber 42 is in a neutral state in which the pressure difference is less than a first differential pressure value, the second annular portion 142 of the intake valve 111 comes into contact with the inner valve seat portion 105 and the outer valve seat portion 106 of the piston 40, thereby blocking the first passage 85 at the blocking portion 145. In addition, in this neutral state, the valve disc 114 of the first stage valve 131 comes into contact with the plurality of convex portions 162 of the slide valve 113 in a state in which the outer circumferential side thereof is bent in the axial direction toward the side opposite to the piston 40. A biasing force of the valve disc 114 generated at this time causes the slide valve 113 to be positioned closest to the piston 40. Furthermore, due to the biasing force of the valve disc 114 generated at this time, the slide valve 113 presses the second annular portion 142 of the intake valve 111 against the inner valve seat portion 105 and the outer valve seat portion 106 of the piston 40 and brings the second annular portion 142 into contact with them.

When a pressure in the lower chamber 42 becomes higher than a pressure in the upper chamber 41 by the first differential pressure value or more, in the damping force generating mechanism 81, the second annular portion 142 of the intake valve 111 moves away from the inner valve seat portion 105 and the outer valve seat portion 106 of the piston 40 while moving the slide valve 113 to the side opposite to the piston 40. Then, the oil liquid L in the lower chamber 42 flows from the first passage 85 to the upper chamber 41 via a passage between the second annular portion 142 of the intake valve 111 and the outer valve seat portion 106 of the piston 40. At the same time, the oil liquid L in the lower chamber 42 flows from the first passage 85 to the upper chamber 41 via a passage between the second annular portion 142 of the intake valve 111 and the inner valve seat portion 105 of the piston 40, the intake valve passage 146 of the intake valve 111, and the third passage 168 including passages inside the plurality of passage holes 165 of the slide valve 113 and passages inside the plurality of radial groove portions 154. At this time, the valve disc 114 of the first stage valve 131 is in contact with the plurality of convex portions 162 of the slide valve 113 and blocks the third passage 168 maximally. When the slide valve 113 moves toward the side opposite to the piston 40, the slide valve 113 moves while deforming the valve disc 114, and the valve disc 114 is deformed while deforming the valve member 117.

When the pressure in the lower chamber 42 becomes higher than the pressure in the upper chamber 41 by a second differential pressure value or more that is higher than the first differential pressure value, in addition to the above, the valve disc 114 of the first stage valve 131 moves away from the plurality of convex portions 162 of the slide valve 113 while deforming the valve member 117 of the second stage valve 132, and opens the third passage 168. Therefore, the oil liquid L in the lower chamber 42 flows from the first passage 85 to the upper chamber 41 via the passage between the second annular portion 142 of the intake valve 111 and the outer valve seat portion 106 of the piston 40. At the same time, the oil liquid L in the lower chamber 42 flows from the first passage 85 to the upper chamber 41 via the passage between the second annular portion 142 of the intake valve 111 and the inner valve seat portion 105 of the piston 40, the intake valve passage 146 of the intake valve 111, and the third passage 168 inside the slide valve 113 including passages inside the plurality of passage holes 165 and passages of the plurality of radial groove portions 154. At this time, the valve disc 114 of the first stage valve 131 is spaced apart from the plurality of convex portions 162 of the slide valve 113 in the axial direction, and opens the third passage 168.

As shown in FIG. 1, a passage 201 and a passage 202 that pass through the valve body 25 in the axial direction are formed in the valve body 25. The passages 201 and 202 are capable of communicating the lower chamber 42 and the reservoir chamber 15 with each other. The base valve 31 has a compression-side damping force generating mechanism 205 capable of opening and closing the passage 201 on the side of the bottom portion 22 of the valve body 25 in the axial direction. The base valve 31 also has an extension-side damping force generating mechanism 206 capable of opening and closing the passage 202 on the side opposite to the bottom portion 22 of the valve body 25 in the axial direction.

In the base valve 31, when the piston rod 45 moves to the compression side to move the piston 40 in a direction in which the lower chamber 42 is narrowed and thus the pressure in the lower chamber 42 becomes higher than a pressure in the reservoir chamber 15 by a predetermined value or more, the damping force generating mechanism 205 opens the passage 201 to allow the oil liquid L in the lower chamber 42 to flow into the reservoir chamber 15, thereby generating a damping force at that time. In other words, when the piston rod 45 moves to the compression side to move the piston 40, the oil liquid Lin the passage 201 flows into the reservoir chamber 15. The damping force generating mechanism 205 is a compression-side damping force generating mechanism. The damping force generating mechanism 205 does not obstruct a flow of the oil liquid Lin the passage 202.

In the base valve 31, when the piston rod 45 moves to the extension side to move the piston 40 toward the side of the upper chamber 41, and thus the pressure in the lower chamber 42 drops below the pressure in the reservoir chamber 15, the damping force generating mechanism 206 opens the passage 202 to allow the oil liquid L in the reservoir chamber 15 to flow into the lower chamber 42, thereby generating a damping force at that time. In other words, when the piston rod 45 moves to the extension side to move the piston 40, the oil liquid L in the passage 202 flows into the lower chamber 42. The damping force generating mechanism 206 is an extension-side damping force generating mechanism. This damping force generating mechanism 206 does not obstruct the flow of oil liquid L in the passage 201. The damping force generating mechanism 206 may be a suction valve that allows the oil liquid L to flow from the reservoir chamber 15 into the lower chamber 42 without generating any substantial damping force.

### <Operation>

In the compression stroke, the piston 40 moves to the side of the lower chamber 42 to increase the pressure in the lower chamber 42 and to decrease the pressure in the upper chamber 41. In the compression stroke in an extremely low speed region in which a piston speed which is an axial movement speed of the piston 40 is equal to or less than a first predetermined value X1, the damping force generating mechanism 81 is in a neutral state, that is, a valve blocked state, and the damping force generating mechanism 91 is also in the valve blocked state. As a result, the oil liquid L in the lower chamber 42 flows into the upper chamber 41 via an orifice 192 of the orifice disc 181, the second passage 95 of the piston 40, the intake valve passage 146 of the intake valve 111, and the third passage 168 of the slide valve 113. Thus, a damping force having orifice characteristics (the damping force is approximately proportional to the square of the piston speed) is generated by the orifice 192. Therefore, in the compression stroke in the extremely low speed region in which the piston speed is equal to or less than the first predetermined value X1, the characteristics of the damping force with respect to the piston speed become hard with a rate of increase in the damping force becoming relatively high with respect to the increase in the piston speed.

In the compression stroke in a low speed region in which the piston speed is greater than the first predetermined value X1 and less than a second predetermined value X2 that is greater than the first predetermined value X1, the pressure in the first passage 85 communicating with the lower chamber 42 increases, and thus, in the damping force generating mechanism 81, the second annular portion 142 of the intake valve 111 moves the slide valve 113 to the side opposite to the piston 40, and moves away from the inner valve seat portion 105 and the outer valve seat portion 106 of the piston 40 while deforming the outer circumferential sides of the valve disc 114 of the first stage valve 131 and the valve member 117 of the second stage valve 132 to the side opposite to the piston 40. Then, the oil liquid L in the lower chamber 42 flows from the first passage 85 to the upper chamber 41 via a passage between the second annular portion 142 of the intake valve 111 and the outer valve seat portion 106 of the piston 40. At the same time, the oil liquid L in the lower chamber 42 flows from the first passage 85 to the upper chamber 41 via the passage between the second annular portion 142 of the intake valve 111 and the inner valve seat portion 105 of the piston 40, the intake valve passage 146 of the intake valve 111, and the third passage 168 including passages inside the plurality of passage holes 165 of the slide valve 113 and passages inside the plurality of radial groove portions 154. At this time, the outer circumferential side of the valve disc 114 is in contact with the plurality of convex portions 162 of the slide valve 113 and blocks the third passage 168 maximally. In the contraction stroke in the low speed region, in the damping force generating mechanism 81, the passage between the second annular portion 142 of the intake valve 111 and the outer valve seat portion 106 of the piston 40, and the passage between the second annular portion 142 of the intake valve 111 and the inner valve seat portion 105 of the piston 40 expand their own flow path cross-sectional areas as the piston speed increases, thereby obtaining a damping force with valve characteristics (characteristics in which the damping force is approximately proportional to the piston speed). Therefore, in the compression stroke in the low speed region in which the piston speed is less than the second predetermined value X2, the rate of increase in the damping force with respect to the increase in the piston speed is lower and softer than in the compression stroke in the extremely low speed region in which the piston speed is equal to or less than the first predetermined value X1.

In the compression stroke in a medium to high speed region in which the piston speed is equal to or greater than the second predetermined value X2, the second annular portion 142 of the intake valve 111 moves the slide valve 113 to the side opposite to the piston 40 further than in the low speed region. Then, the oil liquid L in the lower chamber 42 flows from the first passage 85 to the upper chamber 41 via the passage between the second annular portion 142 and the outer valve seat portion 106, which has a flow passage cross-sectional area expanded more than in the low speed region. At the same time, the oil liquid L in the lower chamber 42 flows from the first passage 85 to the upper chamber 41 via the passage between the second annular portion 142 and the inner valve seat portion 105, which has a flow path cross-sectional area expanded more than in the low speed region, the intake valve passage 146 of the intake valve 111, and the third passage 168 including the passages inside the plurality of passage holes 165 of the slide valve 113 and the passages inside the plurality of radial groove portions 154. At this time, the oil liquid L flowing through the third passage 168 deforms the outer circumferential sides of the valve disc 114 of the first stage valve 131 and the valve member 117 of the second stage valve 132 to the side opposite to the piston 40 more than in the low speed region, and flows into the upper chamber 41 while moving the outer circumferential side of the valve disc 114 away from the plurality of convex portions 162 of the slide valve 113. Therefore, the flow passage cross-sectional area of the third passage 168 is expanded larger than that in the low speed region. Thus, in the damping force generating mechanism 81, the third passage 168 expands the flow path cross-sectional area in accordance with an amount of opening of the valve disc 114 of the first stage valve 131, and thus, in the compression stroke in the medium to high speed region in which the piston speed is equal to or greater than the second predetermined value X2, the rate of increase in the damping force with respect to the increase in the piston speed is lower and softer than in the compression stroke in the low speed region in which the piston speed is less than the first predetermined value X2.

In the compression stroke, the damping force characteristics due to the damping force generating mechanism 205 shown in FIG. 1 are also taken into account.

In the extension stroke, the piston 40 moves to the side of the upper chamber 41 and causes the pressure in the upper chamber 41 to increase and the pressure in the lower chamber 42 to decrease. In the extension stroke in the extremely low speed region in which the piston speed is equal to or less than a third predetermined value X3, the damping force generating mechanism 81 is in the neutral state, that is, the valve blocked state, and the damping force generating mechanism 91 is also in the valve blocked state. As a result, the oil liquid L in the upper chamber 41 flows into the lower chamber 42 via the third passage 168 of the slide valve 113, the intake valve passage 146 of the intake valve 111, the second passage 95 of the piston 40, and the orifice 192 of the orifice disc 181. Thus, a damping force having an orifice characteristic is generated by the orifice 192. Therefore, in the extension stroke in the extremely low speed region in which the piston speed is equal to or less than the third predetermined value X3, the damping force characteristic with respect to the piston speed becomes hard with the rate of increase in the damping force being relatively high with respect to the increase in the piston speed.

In the extension stroke in the low, medium, and high speed region in which the piston speed is greater than the third predetermined value X3, the pressure increases in the third passage 168 of the slide valve 113, the intake valve passage 146 of the intake valve 111, and the second passage 95 of the piston 40 which are communicated with the upper chamber 41, and thus in the damping force generating mechanism 91, the valve member 183 including the orifice disc 181 and the plurality of discs 182 moves away from the valve seat portion 108 of the piston 40. Then, the oil liquid L in the upper chamber 41 flows from the third passage 168 of the slide valve 113, the intake valve passage 146 of the intake valve 111, and the second passage 95 of the piston 40 to the lower chamber 42 via the passage between the valve member 183 and the valve seat portion 108 of the piston 40. Thus, a damping force having valve characteristics is obtained. Therefore, in the extension stroke in the low, medium and high speed region in which the piston speed is greater than the third predetermined value X3, the rate of increase in the damping force with respect to the increase in the piston speed is lower and softer than in the compression stroke in the extremely low speed region in which the piston speed is equal to or less than the third predetermined value X3.

The reference example shown in the above-described Japanese Patent No. 5211166 discloses a cylinder device having an orifice disc and an intake valve disc which open and close a compression passage provided in a valve body, an interface provided on the side of the orifice disc and the intake valve disc opposite to the valve body, and an interface disc provided on the side of the interface opposite to the orifice disc and the intake valve disc. Incidentally, it is required that the damping force be adjustable in the low speed region in which the piston speed is low, the medium speed region in which the piston speed is higher than the low speed region, and the high speed region in which the piston speed is higher than the medium speed region. For example, there is a demand for a valve that has a damping force characteristic that increases the damping force when the piston speed is in the low speed region, and does not become too high in the medium to high speed regions. However, in conventional valves that do not have an actuator, when the damping force in the low speed region in which the piston speed is small is increased, the damping force in the medium to high speed regions also increases, and thus it is difficult to achieve both.

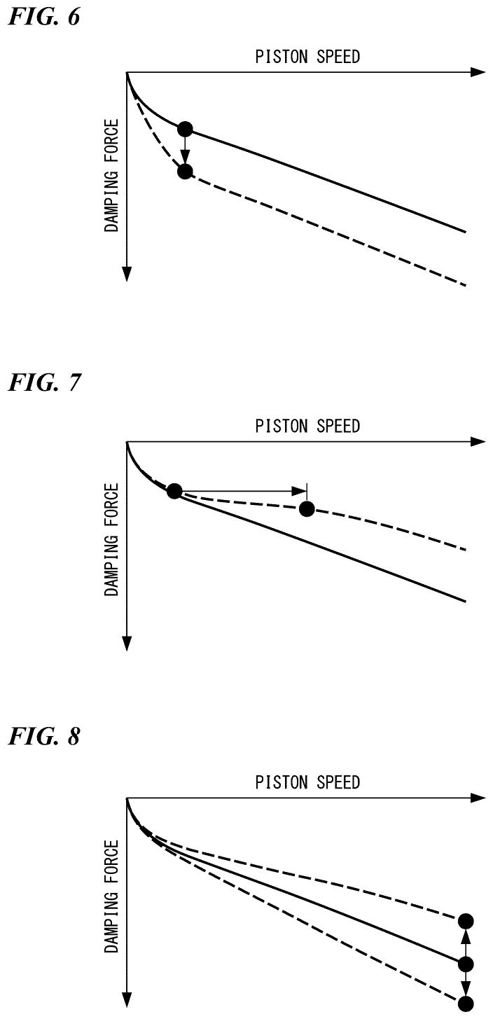

In the cylinder device 11, the damping force generating mechanism 81 that is provided in the first passage 85 through which the oil liquid L flows out as the piston 40 moves and that generates a damping force includes the intake valve 111 that opens and closes the first passage 85, the slide valve 113 of which both the inner and outer circumferences are movable in the axial direction and which has the third passage 168 through which the oil liquid L flowing out of the first passage 85 can flow, and the first stage valve 131 of which the inner circumference is fixed and the outer circumference is bent to adjust the biasing force of the intake valve 111. Therefore, the cylinder device 11 can adjust the damping force in the low speed region in which the piston speed is small to be hard or soft by, for example, changing the thickness of the valve disc 114 and the retainer 115 that constitute the first stage valve 131, as shown by solid and dashed lines in FIG. 6, and can adjust the damping force to be harder or softer in the medium speed region in which the piston speed is higher than in the low speed region and in the high speed region in which the piston speed is higher than in the medium speed region, as shown by the solid and dashed lines in FIG. 7. In this way, the cylinder device 11 is capable of adjusting the damping force in the low speed region in which the piston speed is low, the medium speed region in which the piston speed is higher than the low speed region and the high speed region in which the piston speed is higher than the medium speed region.

The cylinder device 11 also has the second stage valve 132 of which the inner circumference is fixed and the outer circumference is bent to apply a further biasing force to the first stage valve 131 to set the first stage valve 131 at a predetermined distance in the axial direction. The cylinder device 11 has the second stage valve 132 of which the inner circumference is fixed and the outer circumference is bent to control the amount of movement of the first stage valve 131. Therefore, the cylinder device 11 can adjust the damping force to be harder or softer in the medium speed region in which the piston speed is higher than in the low speed region and in the high speed region in which the piston speed is higher than in the medium speed region, for example, by changing the thickness and number of the discs 116 that constitute the second stage valve 132 and the thickness of the retainer 118 that constitutes the second stage valve 132, as shown by solid and dashed lines in FIG. 8. Therefore, the cylinder device 11 can adjust the damping force in more detail in the medium speed region in which the piston speed is higher than the low speed region and in the high speed region in which the piston speed is higher than the medium speed region.

Furthermore, in the cylinder device 11, the intake valve 111 includes the first annular portion 141 having an insertion hole 144 through which the piston rod 45 is inserted, the second annular portion 142 which has a blocking portion 145 that blocks the first passage 85 and has an inner diameter larger than an outer diameter of the first annular portion 141, and a connection portion 143 which connects the first annular portion 141 and the second annular portion 142 to each other in the radial direction. Thus, the second annular portion 142 can open and close the first passage 85 in a state in which displacement in the radial direction is curbed by the first annular portion 141 and the connection portion 143, and thus the first passage 85 can be opened and closed satisfactorily. In addition, the intake valve 111 has excellent damping force tuning properties because a flow rate of the oil liquid L flowing from the lower chamber 42 to the upper chamber 41 can be adjusted by changing the number of connection portions 143 or the thickness of the intake valve 111.

In addition, in the cylinder device 11, the plurality of convex portions 162 are disposed to be spaced apart from each other in the circumferential direction on the side of the slide valve 113 opposite to the first stage valve 131. The cylinder device 11 can adjust the set load of the first stage valve 131 by changing the height of the plurality of convex portions 162. In addition, the cylinder device 11 can adjust the flow rate of the oil liquid L flowing from the lower chamber 42 to the upper chamber 41 by changing the number of convex portions 162, in other words, the number and width of the radial groove portions 154 between the convex portions 162. In other words, the cylinder device 11 can adjust opening flow rates of the slide valve 113 and the first stage valve 131 by changing the number of convex portions 162, in other words, the number and width of the radial groove portions 154 between the convex portions 162.

Here, the set load of the intake valve 111 is applied by the valve disc 114 of the first stage valve 131 via the slide valve 113.

The valve disc 114 of the first stage valve 131 is thin, and a set load is applied by the plurality of convex portions 162 of the slide valve 113.

These points determine an opening point of the valve disc 114 of the first stage valve 131.

When the piston speed becomes high and the flow rate of the oil liquid L increases, the valve disc 114 of the first stage valve 131 opens and the amount of valve opening increases according to the flow rate of the oil liquid L.

The height of the plurality of convex portions 162 of the slide valve 113 contributes to the set load of the valve disc 114 of the first stage valve 131.

The number of the plurality of convex portions 162 of the slide valve 113 adjusts the damping force exerted by the valve member 117 of the second stage valve 132.

When the number of connection portions 143 of the intake valve 111 or the thickness of the intake valve 111 is changed, the flow rate of the oil liquid L flowing from the lower chamber 42 to the upper chamber 41 changes.

In addition, in the cylinder device 11, the plurality of convex portions 162 cause the valve disc 114 of the first stage valve 131 to corrugate in the circumferential direction when the valve disc 114 of the first stage valve 131 is in contact with the slide valve 113. In other words, the number and thickness of the convex portions 162 are set so that the valve disc 114 corrugates in the circumferential direction when the valve disc 114 of the first stage valve 131 is in contact with the slide valve 113. Thus, the cylinder device 11 can apply a desired set load to the intake valve 111 by, for example, the valve disc 114.

### Second Embodiment

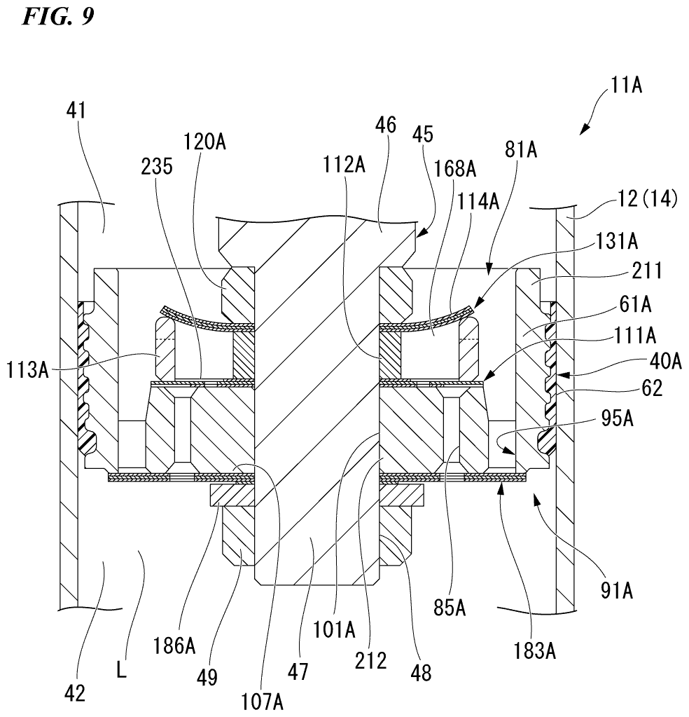

Next, a cylinder device according to a second embodiment of the present invention will be described mainly based on FIGS. 9 to 12, focusing on parts that are the same as those in the first embodiment, with reference to FIGS. 1 to 8. Parts that are common to those in the first embodiment will be designated by the same names and symbols.

### <Configuration>

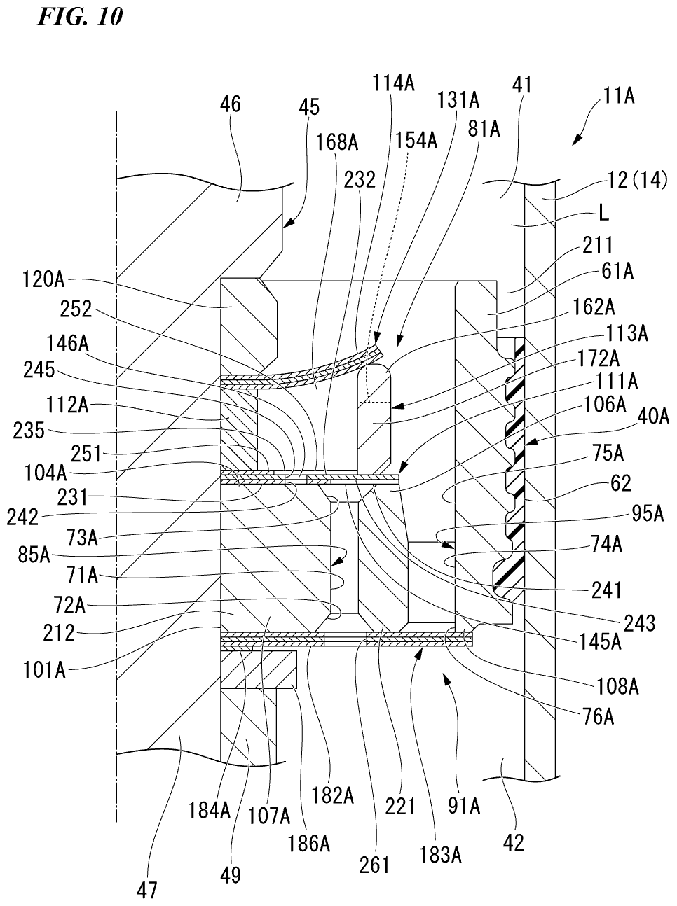

As shown in FIGS. 9 and 10, a cylinder device 11A of the second embodiment includes a piston 40A that is partially different from the piston 40, instead of the piston 40.

The piston 40A includes a piston body 61A that is partially different from the piston body 61, instead of the piston body 61. The piston body 61A has an annular shape and is made of a metal. The piston body 61 has a tubular portion 211 on an outer circumferential portion of which the sliding member 62 is mounted, and a bottom portion 212 that extends radially inward from a lower portion of the tubular portion 211. In the piston body 61A, the mounting shaft portion 47 of the piston rod 45 is inserted through the inner circumferential side of the bottom portion 212.

As shown in FIG. 10, the piston body 61A has, in the bottom portion 212, a plurality of passage holes 71A, an annular concave portion 72A, an annular concave portion 73A, a plurality of passage holes 74A, an annular concave portion 75A, and an annular concave portion 76A.

The plurality of passage holes 71A are disposed at equal pitches in the circumferential direction of the piston body 61A at positions equidistant from a central axis of the piston body 61A. All of the plurality of passage holes 71A form straight lines in the axial direction of the piston body 61A.

The annular concave portion 72A is provided at an end portion of the bottom portion 212 of the piston body 61A on the side of the lower chamber 42. The annular concave portion 72A has an annular shape centered on the central axis of the piston body 61A. The annular concave portion 72A causes opening portions of the plurality of passage holes 71A on the side of the lower chamber 42 to be communicated with each other.

The annular concave portion 73A is provided at an end portion of the bottom portion 212 of the piston body 61A on the side of the upper chamber 41. The annular concave portion 73A has an annular shape centered on the central axis of the piston body 61A. The annular concave portion 73A causes the opening portions of the plurality of passage holes 71A on the side of the upper chamber 41 to be communicated with each other.

The plurality of passage holes 71A, the annular concave portion 72A, and the annular concave portion 73A can communicate the lower chamber 42 and the upper chamber 41 with each other.

The plurality of passage holes 74A are disposed at equal pitches in the circumferential direction of the piston body 61A at positions equidistant from the central axis of the piston body 61A. All of the plurality of passage holes 74A are straight lines in the axial direction of the piston body 61A. A distance of the plurality of passage holes 74A from the central axis of the piston body 61A is longer than a distance of the plurality of passage holes 71A from the central axis of the piston body 61A. Therefore, the plurality of passage holes 74A are disposed in the piston body 61A so as to surround the plurality of passage holes 71A outward of the piston body 61A in the radial direction.

The annular concave portion 75A is provided at an end portion of the bottom portion 212 of the piston body 61A on the side of the upper chamber 41. The annular concave portion 75A has an annular shape centered on the central axis of the piston body 61A. The annular concave portion 75A communicates the opening portions of the passage holes 74A on the side of the upper chamber 41 with each other. The annular concave portion 75A is disposed radially outward of the piston body 61A in the radial direction with respect to the annular concave portion 73A. Thus, the annular concave portion 75A is provided coaxially with the annular concave portion 73A to surround the annular concave portion 73A outward in the radial direction. The annular concave portion 75A overlaps the annular concave portion 73A in the axial direction of the piston body 61A.

The annular concave portion 76A is provided at an end portion of the bottom portion 212 of the piston body 61A on the side of the lower chamber 42. The annular concave portion 76A has an annular shape centered on the central axis of the piston body 61A. The annular concave portion 76A communicates the opening portions of the plurality of passage holes 74A on the side of the lower chamber 42 with each other. The annular concave portion 76A is disposed outward of the piston body 61A in the radial direction with respect to the annular concave portion 72A. Thus, the annular concave portion 76A is provided coaxially with the annular concave portion 72A to surround the annular concave portion 72A outward in the radial direction. The annular concave portion 76A overlaps the annular concave portion 72A in the axial direction of the piston body 61A.

The plurality of passage holes 74A, the annular concave portion 75A, and the annular concave portion 76A can communicate the upper chamber 41 and the lower chamber 42 with each other.

A damping force generating mechanism 81A is provided for the plurality of passage holes 71A and the annular concave portions 72A and 73A. The damping force generating mechanism 81A opens and closes passages within the plurality of passage holes 71A and passages within the annular concave portions 72A and 73A to generate a damping force. The damping force generating mechanism 81A is mounted on the piston rod 45. The damping force generating mechanism 81A is disposed on the side of the upper chamber 41 which is one end side of the piston 40A in the axial direction. Thus, the passages within the plurality of passage holes 71A and the passages within the annular concave portions 72A and 73A become a first passage 85A through which the oil liquid L flows from the lower chamber 42 toward the upper chamber 41 as the piston 40A moves toward the side of the lower chamber 42. The first passage 85A is a compression-side passage through which the oil liquid L flows from the lower chamber 42 toward the upper chamber 41 in the compression stroke of the piston rod 45. The damping force generating mechanism 81A provided in the first passage 85A is a compression-side damping force generating mechanism that generates a damping force by controlling a flow of the oil liquid L in the first passage 85A.

A damping force generating mechanism 91A is provided for the plurality of passage holes 74A and the annular concave portions 75A and 76A. The damping force generating mechanism 91A opens and closes passages within the plurality of passage holes 74A and passages within the annular concave portions 75A and 76A to generate a damping force. The damping force generating mechanism 91A is mounted on the piston rod 45. The damping force generating mechanism 91A is disposed on the other end side of the bottom portion 212 of the piston 40A opposite to the damping force generating mechanism 81A provided on one end side of the bottom portion 212 of the piston 40A in the axial direction, that is, on the side of the lower chamber 42. Thus, the passages within the plurality of passage holes 74A and the passages within the annular concave portions 75A and 76A become a second passage 95A through which the oil liquid L flows from the upper chamber 41 toward the lower chamber 42 as the piston 40A moves toward the side of the upper chamber 41. The second passage 95A is an extension-side passage through which the oil liquid L flows from the upper chamber 41 toward the lower chamber 42 in the extension stroke of the piston rod 45. The damping force generating mechanism 91A provided in the second passage 95A is an extension-side damping force generating mechanism that generates a damping force by controlling the flow of the oil liquid L in the passage inside the second passage 95A. The damping force generating mechanism 81A may be used as the extension-side damping force generating mechanism instead of the damping force generating mechanism 91A. In this case, the compression-side damping force generating mechanism becomes the damping force generating mechanism 91A.

As a result of the above, the first passage 85A and the second passage 95A communicate the upper chamber 41 and the lower chamber 42 with each other so that the oil liquid L can flow therebetween as the piston 40A moves. The oil liquid L passes through the first passage 85A when the piston rod 45 and the piston 40A move toward the compression side. The oil liquid L passes through the second passage 95A when the piston rod 45 and the piston 40A move toward the extension side.

The piston body 61A has a generally cylindrical shape with a bottom. A fitting hole 101A is formed in the piston body 61A. The fitting hole 101A is formed in the center of the piston body 61A in the radial direction. The fitting hole 101A passes through the bottom portion 212 of the piston body 61A in the axial direction of the piston body 61A. The mounting shaft portion 47 of the piston rod 45 is fitted into the fitting hole 101A. Thus, the piston body 61A and the piston 40A including the piston body 61A are positioned in the radial direction relative to the mounting shaft portion 47 of the piston rod 45.

The piston body 61A has an inner seat portion 104A, a valve seat portion 106A, an inner seat portion 107A, an inner valve seat portion 221, and an outer valve seat portion 108A.

The inner seat portion 104A and the valve seat portion 106A are both provided at the end portion of the bottom portion 212 of the piston body 61 on the side of the upper chamber 41 in the axial direction.

The inner seat portion 104A is disposed between the fitting hole 101A of the piston body 61A and the annular concave portion 73A. The inner seat portion 104A has an annular shape.

The valve seat portion 106A is disposed between the annular concave portion 73A and the annular concave portion 75A. The valve seat portion 106A has an annular shape, has a larger diameter than the inner seat portion 104A and is disposed coaxially with the inner seat portion 104A.

The inner seat portion 104A and the valve seat portion 106A align a position of an outer end surface of the bottom portion 212 of the piston body 61A in the axial direction. The piston body 61A has the annular concave portion 73A between the inner seat portion 104A and the valve seat portion 106A, and has the annular concave portion 75A between the valve seat portion 106A and the tubular portion 211.

The inner seat portion 107A, the inner valve seat portion 221, and the outer valve seat portion 108A are all provided at the end portion of the piston body 61A on the side of the lower chamber 42 in the axial direction.

The inner seat portion 107A is disposed between the fitting hole 101A of the piston body 61A and the annular concave portion 72A. The inner seat portion 107A has an annular shape.

The inner valve seat portion 221 is disposed between the annular concave portion 72A and the annular concave portion 76A. The inner valve seat portion 221 has an annular shape, has a larger diameter than the inner seat portion 107A and is disposed coaxially with the inner seat portion 107A.

The outer valve seat portion 108A is disposed outward of the annular concave portion 76A in the radial direction. The outer valve seat portion 108A has an annular shape, has a larger diameter than the inner valve seat portion 221 and is disposed coaxially with the inner valve seat portion 221.

An outer end surface of the inner valve seat portion 221 in the axial direction of the piston body 61A is located slightly outward in the axial direction of the piston body 61A than an outer end surface of the inner seat portion 107A in the axial direction of the piston body 61A. In other words, the inner valve seat portion 221 protrudes slightly outward of the inner seat portion 107A in the axial direction of the piston body 61A. The piston body 61A has then annular concave portion 72A between the inner seat portion 107A and the inner valve seat portion 221.

An outer end surface of the outer valve seat portion 108A in the axial direction of the piston body 61A is located slightly outward in the axial direction of the piston body 61A than an outer end surface of the inner valve seat portion 221 in the axial direction of the piston body 61A. In other words, the outer valve seat portion 108A protrudes slightly outward of the inner valve seat portion 221 in the axial direction of the piston body 61A. The piston body 61A has an annular concave portion 76A between the inner valve seat portion 221 and the outer valve seat portion 108A.

In the piston body 61A, the compression-side first passage 85A is disposed inward of the valve seat portion 106A and the inner valve seat portion 221 in the radial direction. In the piston body 61A, the extension-side second passage 95A is disposed outward of the valve seat portion 106A and the inner valve seat portion 221 and inward of the outer valve seat portion 108A in the radial direction.

The piston 40A is fitted onto the mounting shaft portion 47 in a state in which the inner seat portion 104A and the valve seat portion 106A face toward the main shaft portion 46 in the axial direction. The valve seat portion 106A of the piston 40A constitutes a part of damping force generating mechanism 81A. The inner valve seat portion 221 and the outer valve seat portion 108A of the piston 40A constitute a part of the damping force generating mechanism 91A.

In a state in which the mounting shaft portion 47 is inserted inward in the radial direction between the main shaft portion 46 and the piston 40A, one valve disc 231, one valve disc 232, one support member 235, one spacer 112A, three valve discs 114A, and one washer 120A are provided on the mounting shaft portion 47 of the piston rod 45 in this order from the side of the piston 40A. Furthermore, one slide valve 113A (a second valve) is provided in the axial direction between the valve disc 232 and the three valve discs 114A and outward of the support member 235 and the spacer 112A in the radial direction. The valve discs 231 and 232 constitute an intake valve 111A (a first valve). The three valve discs 114A constitute a pressure valve 131A (a third valve).

The valve discs 231 and 232, the support member 235, the spacer 112A, the valve disc 114A and the washer 120A are positioned in the radial direction with respect to the mounting shaft portion 47 by inserting the mounting shaft portion 47 inward in the radial direction. In addition, at least inner circumferential sides of the valve discs 231 and 232, the support member 235, the spacer 112A, the valve disc 114A, and the washer 120A are sandwiched between the main shaft portion 46 of the piston rod 45 and the inner seat portion 104A of the piston 40A in a state in which they are pressurized in the axial direction, and thus at least the inner circumferential sides are fixed to the mounting shaft portion 47 of the piston rod 45.

The intake valve 111A having the valve discs 231 and 232, the support member 235, the spacer 112A, the slide valve 113A, the valve disc 114A, and the washer 120A constitute the damping force generating mechanism 81A. A shape of a contact surface of the slide valve 113A is not limited as long as it is a shape suitable for applying a set load to the intake valve 111A at a contact surface between the intake valve 111A and the slide valve 113A. For example, a cross-sectional shape of the slide valve 113A in a plane including the central axis thereof may be flat, or may be convex toward the intake valve 111A. In addition, when it is convex, a position of the convexity with respect to the intake valve 111A can be set arbitrarily.

The valve discs 231 and 232 constituting the intake valve 111A are both made of a metal and have a circular flat plate shape with a hole. Each of the valve discs 231 and 232 is formed by press molding from a single flat plate material. The mounting shaft portion 47 of the piston rod 45 is inserted through the inner side of each of the valve discs 231 and 232 in the radial direction.

A plurality of cutout portions 241 having the same shape are formed at equal intervals in the circumferential direction on a radially outer portion of the valve disc 231. The cutout portions 241 open to the outer side of the valve disc 231 in the radial direction and pass through the valve disc 231 in the axial direction. A passage hole 242 passing therethrough in the axial direction is formed at a portion of the valve disc 231 inward of the plurality of cutout portions 241 in the radial direction. The valve disc 231 has an annular shape of which a width in the radial direction is constant except for the cutout portion 241.

The valve disc 231 has an outer diameter equal to an outer diameter of the valve seat portion 106A of the piston 40A, and may come into contact with the valve seat portion 106A in the axial direction. The valve disc 231 comes into contact with the inner seat portion 104 in the axial direction. Thus, the valve disc 231 has a blocking portion 145A that blocks the first passage 85A.

The plurality of cutout portions 241 are provided in the blocking portion 145A and are provided outward in the radial direction with respect to the inner seat portion 104A of the piston 40A. The plurality of cutout portions 241 may communicate the first passage 85A and the upper chamber 41 with each other even when the blocking portion 145A is in contact with the valve seat portion 106A. The plurality of cutout portions 241 form an orifice 243 that constantly communicates the first passage 85A and the upper chamber 41 with each other.

The passage hole 242 has an arc shape centered on a central axis of the valve disc 231. The passage hole 242 is provided inward in the radial direction with respect to an outer end portion of an upper end surface of the inner seat portion 104A in the radial direction. Thus, when the valve disc 231 is not deformed, the passage hole 242 is blocked by the inner seat portion 104A and does not communicate with the first passage 85A. When the valve disc 231 deforms in a direction away from the valve seat portion 106A, the passage hole 242 moves away from the inner seat portion 104A and communicates with the first passage 85A.

The valve disc 232 has the same outer diameter as the valve disc 231, and a width thereof in the radial direction is constant over the entire circumference. The valve disc 232 is formed with a passage hole 245 that passes therethrough in the axial direction. The passage hole 245 has an arc shape that extends in the circumferential direction of the valve disc 232. The passage hole 245 is aligned with the passage hole 242 in the radial direction of the valve discs 231 and 232, and constantly communicates with the passage hole 242.

When the valve disc 231 is in contact with the valve seat portion 106A, the intake valve 111A closes the first passage 85A from the upper chamber 41 with the blocking portion 145A. When the blocking portion 145A of the valve disc 231 moves away from the valve seat portion 106A, the intake valve 111A communicates the first passage 85A with the upper chamber 41 via a passage between the blocking portion 145A and the valve seat portion 106A. Therefore, the intake valve 111A opens and closes the first passage 85A.

In the intake valve 111A, when the blocking portion 145A of the valve disc 231 moves away from the valve seat portion 106A, the passage hole 242 also moves away from the inner seat portion 104A. When the passage hole 242 moves away from the inner seat portion 104A in this manner, the intake valve 111A communicates the passage hole 242 of the valve disc 231 and the passage hole 245 of the valve disc 232 with the first passage 85A. In the intake valve 111A, the passage hole 242 of the valve disc 231 and the passage hole 245 of the valve disc 232 form an intake valve passage 146A that can communicate with the first passage 85A.

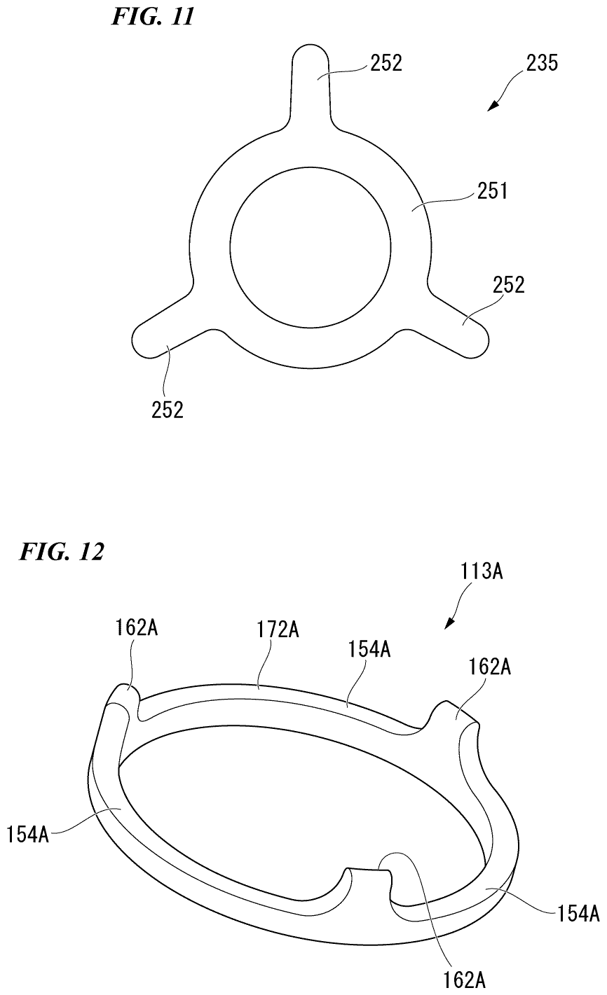

The support member 235 is made of a metal and has a flat plate shape with a hole. The support member 235 is formed by press molding from a single flat plate material. As shown in FIG. 11, the support member 235 has a base portion 251 and an extension portion 252.

The base portion 251 has an annular shape that has a constant width in the radial direction. The mounting shaft portion 47 of the piston rod 45 is inserted through the radially inner side of the base portion 251. The base portion 251 has an outer radius that is smaller than a minimum distance from the central axis of the valve disc 232 to the passage hole 245. Thus, the base portion 251 does not overlap the passage hole 245 of the valve disc 232.

The extension portion 252 extends outward in the radial direction of the base portion 251 from an outer circumferential edge of the base portion 251. The support member 235 has a plurality of extension portions 252 having the same shape and arranged at equal intervals in the circumferential direction of the base portion 251.

The spacer 112A is made of a metal and has a cylindrical shape. The mounting shaft portion 47 of the piston rod 45 is inserted through the inner side of the spacer 112A in the radial direction. An outer diameter of the spacer 112A is smaller than an outer diameter of the base portion 251 of the support member 235. The spacer 112A comes into contact with the base portion 251 of the support member 235.

The slide valve 113A is made of a metal and has an annular shape. The slide valve 113A is formed by sintering or cutting.

As shown in FIG. 12, the slide valve 113A has an annular portion 172A and a convex portion 162A.

The annular portion 172A has an annular shape with a constant height in the axial direction and a constant width in the radial direction.

The convex portion 162A protrudes outward in the axial direction of the annular portion 172A from one axial end surface of the annular portion 172A. The slide valve 113A has a plurality of, specifically three, convex portions 162A which have the same shape, protrude from the annular portion 172A to the same side in the axial direction of the annular portion 172A, and are spaced apart from each other at equal intervals in the circumferential direction of the annular portion 172A. In outer tip end surfaces of the plurality of convex portions 162A of the slide valve 113A in the axial direction of the slide valve 113A, inner edge portions in the radial direction of the slide valve 113A are disposed on the same circle. In the outer tip end surfaces of the plurality of convex portions 162A of the slide valve 113A in the axial direction of the slide valve 113A, outer edge portions in the radial direction of the slide valve 113A are also disposed on the same circle. In the outer tip surfaces of the plurality of convex portions 162A of the slide valve 113A in the axial direction of the slide valve 113A, outer edge portions in the axial direction are also disposed on the same circle.

In the slide valve 113A, a space between the adjacent convex portions 162A in the circumferential direction of the annular portion 172A forms a radial groove portion 154A that passes through the slide valve 113A in the radial direction and opens on the side opposite to the annular portion 172A in the axial direction of the slide valve 113A. In the slide valve 113A, the radial groove portions 154A having the same shape are formed between all of the convex portions 162A adjacent to each other in the circumferential direction of the slide valve 113A. Therefore, a plurality of radial groove portions 154A which have the same shape and are the same number as the number of convex portions 162A, specifically three, at equal intervals in the circumferential direction of the slide valve 113A are provided in the slide valve 113A.

As shown in FIG. 10, an outer diameter of the slide valve 113A is slightly smaller than an outside diameter of the intake valve 111A. A radius of the inner diameter side of the annular portion 172A, which is a radius of the inner diameter side of the slide valve 113A, is slightly larger than a radius from the central axis of the support member 235 to a tip end of the extension portion 252. The radius of the inner diameter side of the slide valve 113A is larger than a minimum distance from the central axis of the piston 40A to the first passage 85A. In other words, an inner end of the slide valve 113A in the radial direction is located outward with respect to an inner end of the first passage 85A of the piston 40A in the radial direction.

The slide valve 113A is placed on the valve disc 232 of the intake valve 111A at the annular portion 172A in a state in which the convex portion 162A faces the side opposite to the intake valve 111A in the axial direction and the spacer 112A and the support member 235 are disposed inward in the radial direction. At this time, the slide valve 113A is positioned in the radial direction by the plurality of extension portions 252 of the support member 235 provided on the inner side of the annular portion 172A in the radial direction. That is, even when the slide valve 113A attempts to move in the radial direction, it comes into contact with the extension portion 252 of the support member 235, and the movement in the radial direction is restricted. The support member 235 has the base portion 251 fixed to the piston rod 45 and the plurality of extension portions 252 that extend from the base portion 251 and can come into contact with an inner circumferential surface of the support member 235, and the plurality of extension portions 252 support the movement of the slide valve 113A in the axial direction while restricting the movement of the slide valve 113A in the radial direction. The support member 235 supports the slide valve 113A with the plurality of extension portions 252, and has a passage, which passes therethrough in the axial direction, on the inner side with respect to an outer end in the radial direction. In the slide valve 113A, a radius of the inner diameter side of the annular portion 172A that is a radius of the inner diameter side thereof is larger than a maximum distance from the central axis of the valve disc 232 to the passage hole 245.

An axial length of the slide valve 113A, that is, an axial distance between opposed end surfaces of the annular portion 172A and the plurality of convex portions 162A, is longer than a combined length of an axial thickness of the spacer 112A and an axial thickness of the support member 235.

In the slide valve 113A, a space inside the plurality of radial groove portions 154A and a space between the spacer 112A on the inner side in the radial direction and the support member 235 form a third passage 168A. The third passage 168A may communicate with the first passage 85A via a passage between the intake valve 111A and the inner seat portion 104A of the piston 40A which are spaced apart, and the intake valve passage 146A of the intake valve 111A. When the valve disc 231 of the intake valve 111A separates the passage hole 242 from the inner seat portion 104A of the piston 40A, the third passage 168A communicates with the first passage 85A and allows the oil liquid L flowing out of the first passage 85A to flow therethrough. When the third passage 168A communicates with the first passage 85A, it communicates the first passage 85A with the upper chamber 41.

The plurality of valve discs 114A constituting the pressure valve 131A are all made of a metal and have the same shape. Before the plurality of valve discs 114A are assembled to the piston rod 45, each of the plurality of valve discs 114A has a circular flat plate shape with a hole. The valve discs 114A are formed by press molding from a single flat plate material. The valve disc 114A has a constant width in the radial direction over the entire circumference. The mounting shaft portion 47 of the piston rod 45 is inserted through the inner side of the valve disc 114A in the radial direction. An inner circumference of the pressure valve 131A is fixed to the mounting shaft portion 47 of the piston rod 45.

As described above, in the outer tip surfaces of the plurality of convex portions 162A of the slide valve 113A in the axial direction of the slide valve 113A, the outer edge portions in the axial direction are disposed on the same circle, but an outer diameter of the pressure valve 131A is larger than a diameter of the circle. Furthermore, a combined axial thickness of the spacer 112A and the support member 235 is thinner than an axial thickness at positions of the plurality of convex portions 162A of the slide valve 113A, that is, a distance between the end surfaces of the convex portions 162A and the annular portion 172A that face each other in the axial direction of the slide valve 113A. Therefore, when the pressure valve 131A comes into contact with the plurality of convex portions 162A of the slide valve 113A, the outer circumference side of the pressure valve 131A is bent in the axial direction to move away from the bottom portion 212 of the piston 40A. At this time, the plurality of convex portions 162A are disposed at intervals in the circumferential direction on the side of the slide valve 113A opposite to the pressure valve 131A. Therefore, in a state in which the pressure valve 131A is in contact with the plurality of convex portions 162A of the slide valve 113A, a portion of the pressure valve 131A that is not in contact with the plurality of convex portions 162A deforms in the axial direction so as to enter the radial groove portion 154A. Therefore, when the pressure valve 131A comes into contact with the slide valve 113A, the plurality of convex portions 162A cause the pressure valve 131A to corrugate in the circumferential direction.

In a state in which the outer circumferential side of the pressure valve 131A is in contact with the plurality of convex portions 162A of the slide valve 113A, the pressure valve 131A corrugates to enter the radial groove portion 154A, thereby blocking the third passage 168A of the slide valve 113A maximally and minimizing an amount of communication between the third passage 168A and the upper chamber 41. When the outer circumference of the pressure valve 131A bends and moves away from the plurality of convex portions 162A of the slide valve 113A in the axial direction, the pressure valve 131A opens the third passage 168A and increases the amount of communication between the third passage 168A and the upper chamber 41. In this way, the pressure valve 131A is capable of opening and closing the third passage 168A. The pressure valve 131A can bend at its outer circumference to bias the intake valve 111A via the slide valve 113A and can adjust a biasing force of the intake valve 111A. The support member 235 indirectly supports the inner circumference of the pressure valve 131A via the spacer 112A.

The washer 120A is made of a metal and has an annular shape with a hole. The washer 120A is formed from a single member by cutting or the like. A radial width of the washer 120A is constant over the entire circumference. The mounting shaft portion 47 of the piston rod 45 is inserted through the inner side of the washer 120A in the radial direction. An outer diameter of the washer 120A is smaller than the outer diameter of the valve disc 114A. The washer 120A is thicker and more rigid than the valve disc 114A.

In the outer tip surfaces of the plurality of convex portions 162A of the slide valve 113A in the axial direction of the slide valve 113A, a diameter of the same circle on which the outer edge portions in the axial direction are disposed is larger than the outer diameter of the washer 120A.

In a state in which the mounting shaft portion 47 is inserted inward in the radial direction on the side opposite to the main shaft portion 46 in the axial direction of the piston 40A, a valve member 183A including a plurality of discs 182A, one retainer 184A, and one washer 186A are provided in this order from the side of the piston 40A at the mounting shaft portion 47 of the piston rod 45.

By inserting the mounting shaft portion 47 inward in the radial direction, the plurality of discs 182A, the retainer 184A, and the washer 186A are positioned in the radial direction with respect to the mounting shaft portion 47 of the piston rod 45. At least the inner circumferential sides of the valve member 183A, the retainer 184A and the washer 186A are sandwiched between the inner seat portion 107A of the piston 40 and the nut 49 in a state in which they are pressurized in the axial direction, and thus at least the inner circumferential sides are fixed to the piston rod 45. The valve member 183A, the retainer 184A, and the washer 186A constitute the damping force generating mechanism 91A.

The plurality of discs 182A constituting the valve member 183A have the same shape. The discs 182A are made of a metal and have a circular flat plate shape with a hole. The discs 182A are formed by press molding from a single flat plate material. The discs 182A have a constant radial width over the entire circumference. The mounting shaft portion 47 of the piston rod 45 is inserted through the inner sides of the discs 182A in the radial direction. An outer diameter of each of the discs 182A is equal to an outer diameter of the outer valve seat portion 108A of the piston 40A.

A passage hole 261 that passes therethrough in the axial direction is formed in the disc 182A. The passage hole 261 has an arc shape that extends in the circumferential direction of the disc 182A. The passage hole 261 is located radially inward of the inner valve seat portion 221 of the piston 40A and is aligned radially with the annular concave portion 72A. The plurality of discs 182A overlap each other in the axial direction to form the valve member 183A, and at this time, the passage holes 261 thereof are communicated.

The valve member 183A comes into contact with the outer valve seat portion 108A and the inner valve seat portion 221 of the piston 40A and thus closes the second passage 95A. When the valve member 183A moves away from the outer valve seat portion 108A of the piston 40A, it opens the second passage 95A.

The retainer 184A is made of a metal and has a circular flat plate shape with a hole. The retainer 184A is formed by press molding from a single flat plate material. The retainer 184A has a constant radial width over the entire circumference. The mounting shaft portion 47 of the piston rod 45 is inserted through the inner side of the retainer 184A in the radial direction. The retainer 184A has an outer diameter smaller than the outer diameter of the valve member 183A. A radius of the outer diameter side of the retainer 184A is shorter than a minimum length from the central axis of the disc 182A to the passage hole 261.

The washer 186A is made of a metal and has an annular shape with a hole. The washer 186A is formed from a single member by cutting or the like. A radial width of the washer 186A is constant over the entire circumference. The mounting shaft portion 47 of the piston rod 45 is inserted through the inner side of the washer 186A in the radial direction. An outer diameter of the washer 186A is larger than an outer diameter of the retainer 184A. A radius of the outer diameter side of the washer 186A is shorter than a minimum length from the central axis of the disc 182A to the passage hole 261.

The entire slide valve 113A is movable in the axial direction with respect to the spacer 112A, that is, with respect to the piston rod 45 to which the spacer 112A is fixed. In other words, both the inner and outer circumferences of the slide valve 113A are movable in the axial direction with respect to the spacer 112A and the piston rod 45.

When a pressure difference between the upper chamber 41 and the lower chamber 42 is in a neutral state in which the pressure difference is less than a first differential pressure value, the intake valve 111A comes into contact with the valve seat portion 106A of the piston 40A and closes the first passage 85A together with the blocking portion 145A. In addition, in this neutral state, the valve disc 114A of the pressure valve 131A comes into contact with the plurality of convex portions 162A of the slide valve 113A in a state in which the outer circumferential side thereof is bent in the axial direction toward the side opposite to the piston 40A. A biasing force of the valve disc 114A generated at this time causes the slide valve 113A to be positioned closest to the bottom portion 212 of the piston 40A. Furthermore, the biasing force of the valve disc 114A generated at this time causes the slide valve 113A to pressurize the intake valve 111A and bring it into contact with the valve seat portion 106A of the piston 40A.

When a pressure in the lower chamber 42 becomes higher than a pressure in the upper chamber 41 by the first differential pressure value or more, in the damping force generating mechanism 81A, the intake valve 111A moves away from the valve seat portion 106A of the piston 40A while moving the slide valve 113A to the side opposite to the bottom portion 212 of the piston 40A, and also moves the passage hole 242 away from the inner seat portion 104A. Then, the oil liquid L in the lower chamber 42 flows from the first passage 85A to the upper chamber 41 via a passage between the intake valve 111A and the valve seat portion 106A of the piston 40. At the same time, the oil liquid L in the lower chamber 42 flows from the first passage 85A to the upper chamber 41 via a passage between the separated intake valve 111A and the inner seat portion 104A of the piston 40A, the intake valve passage 146A of the intake valve 111A, and the third passage 168A including passages inside the slide valve 113A in the radial direction and passages inside the plurality of radial groove portions 154A. At this time, the valve disc 114A of the pressure valve 131A is in contact with the plurality of convex portions 162A of the slide valve 113A, and a portion thereof that is not in contact with the convex portions 162A is inserted into the radial groove portion 154A to block the third passage 168A maximally. The third passage 168A allows the oil liquid L flowing out of the first passage 85A to flow therethrough.

Here, when the intake valve 111A deforms to move away from the valve seat portion 106A of the piston 40A while moving the slide valve 113A to the side opposite to the bottom portion 212 of the piston 40A, the support member 235 also deforms to follow the deformation of the intake valve 111A. Therefore, the support member 235 is maintained in a state in which it is located within an inner range of the slide valve 113A in the radial direction, and the slide valve 113A is maintained in a state in which it is located in the radial direction. That is, even when the slide valve 113A attempts to move in the radial direction, the extension portion 252 of the support member 235 comes into contact with the slide valve 113A and restricts the radial movement of the slide valve 113A. In other words, the slide valve 113A moves in the axial direction while being maintained in a state in which it is positioned in the radial direction by the support member 235. In other words, the support member 235 is provided on the inner circumferential side of the slide valve 113A to restrict the radial movement of the slide valve 113A while supporting the axial movement thereof. The support member 235 indirectly supports the inner circumference of the pressure valve 131A via the spacer 112A. When the slide valve 113A moves in a direction away from the bottom portion 212 of the piston 40A, it moves while deforming the valve disc 114A of the pressure valve 131A. The slide valve 113A moves in the axial direction while being maintained in the state in which it is positioned in the radial direction by the support member 235, and thus moves without coming into contact with the spacer 112A. In the state in which the slide valve 113A is positioned in the radial direction by the support member 235, the entire slide valve 113A is located outward with respect to an inner end of the first passage 85A in the radial direction of the piston 40A.

When the pressure in the lower chamber 42 becomes higher than the pressure in the upper chamber 41 by a second differential pressure value or more that is higher than the first differential pressure value, in addition to the above, the valve disc 114A of the pressure valve 131A moves away from the plurality of convex portions 162A of the slide valve 113A and opens the third passage 168A. Therefore, the oil liquid L in the lower chamber 42 flows from the first passage 85A to the upper chamber 41 via the passage between the intake valve 111A and the valve seat portion 106A of the piston 40A. At the same time, the oil liquid L in the lower chamber 42 flows from the first passage 85A to the upper chamber 41 via the passage between the separated intake valve 111A and the inner seat portion 104A of the piston 40A, the intake valve passage 146A of the intake valve 111A, and the third passage 168A in the slide valve 113A including passages inside the plurality of radial groove portions 154A. At this time, the valve disc 114A of the pressure valve 131A is spaced apart in the axial direction from the plurality of convex portions 162A of the slide valve 113A and opens the third passage 168A. Furthermore, at this time, the slide valve 113A is maintained in a state in which it is contact with the intake valve 111A by a force of the oil liquid L flowing between the slide valve 113A and the pressure valve 131A, and is not separated from the support member 235.

### <Operation>

In the compression stroke, the piston 40A moves to the side of the lower chamber 42 to increase the pressure in the lower chamber 42 and to decrease the pressure in the upper chamber 41. In the compression stroke in an extremely low speed region in which a piston speed, which is a movement speed of the piston 40A in the axial direction, is equal to or less than a first predetermined value X1, the damping force generating mechanism 81A is in a neutral state, that is, a valve blocked state, and the damping force generating mechanism 91A is also in the valve blocked state. Therefore, the oil liquid L in the lower chamber 42 flows into the upper chamber 41 via the passage holes 261 of the plurality of discs 182A constituting the valve member 183A, the first passage 85A, and the orifice 243 of the intake valve 111A. Thus, a damping force having orifice characteristics (the damping force is approximately proportional to the square of the piston speed) is generated by the orifice 243. Therefore, in the compression stroke in the extremely low speed region in which the piston speed is equal to or less than the first predetermined value X1, the characteristic of the damping force with respect to the piston speed becomes hard with a rate of increase in the damping force becoming relatively high with respect to the increase in the piston speed.

In the compression stroke in the low speed region in which the piston speed is greater than the first predetermined value X1 and less than a second predetermined value X2 that is greater than the first predetermined value X1, the pressure in the first passage 85A communicating with the lower chamber 42 increases, and thus, in the damping force generating mechanism 81A, the intake valve 111A moves the slide valve 113A to the side opposite to the bottom portion 212 of the piston 40A, and moves away from the valve seat portion 106A of the piston 40A while deforming the outer circumferential side of the pressure valve 131A to the side opposite to the bottom portion 212 of the piston 40A. Then, the oil liquid L in the lower chamber 42 flows from the first passage 85A to the upper chamber 41 via the passage between the intake valve 111A and the valve seat portion 106A of the piston 40A. At the same time, as the intake valve 111A is deformed and the intake valve passage 146A is spaced apart from the inner seat portion 104A of the piston 40A, the oil liquid L in the lower chamber 42 flows from the first passage 85A to the upper chamber 41 via the passage between the intake valve 111A and the inner seat portion 104A of the piston 40A, the intake valve passage 146A, and the third passage 168A including the passages in the plurality of radial groove portions 154A of the slide valve 113A. At this time, the outer circumferential side of the valve disc 114A is in contact with the plurality of convex portions 162A of the slide valve 113A and blocks the third passage 168A maximally. In the compression stroke in the low speed range, in the damping force generating mechanism 81A, the passage between the intake valve 111A and the valve seat portion 106A of the piston 40A and the passage between the intake valve 111A and the inner seat portion 104A of the piston 40A expand their own flow path cross-sectional areas in accordance with the increase in piston speed, thereby obtaining a damping force with valve characteristics (characteristics in which the damping force is approximately proportional to the piston speed). Therefore, in the compression stroke in the low speed region in which the piston speed is less than the second predetermined value X2, the rate of increase in damping force with respect to the increase in the piston speed is lower and softer than in the compression stroke in the extremely low speed region in which the piston speed is equal to or less than the first predetermined value X1.

In the compression stroke in a medium to high speed range in which the piston speed is equal to or greater than the second predetermined value X2, the intake valve 111A moves the slide valve 113A to the side opposite to the piston 40 further than in the low speed range. Then, the oil liquid L in the lower chamber 42 flows from the first passage 85A to the upper chamber 41 via the passage between the slide valve 113A and the valve seat portion 106A, which has a flow passage cross-sectional area expanded more than in the low speed region. At the same time, the oil liquid L in the lower chamber 42 flows from the first passage 85A to the upper chamber 41 via the passage between the intake valve 111A and the inner seat portion 104A, which has a flow path cross-sectional area expanded more than in the low speed region, the intake valve passage 146A of the intake valve 111A, and the third passage 168A including the passages inside the plurality of radial groove portions 154A of the slide valve 113A. At this time, the oil liquid L flowing through the third passage 168A deforms the outer circumferential side of the valve disc 114A of the pressure valve 131A to the side opposite to the piston 40A more than in the low speed region, and flows into the upper chamber 41 while moving the outer circumferential side of the valve disc 114A away from the plurality of convex portions 162A of the slide valve 113A. Therefore, the flow passage cross-sectional area of the third passage 168A is expanded larger than that in the low speed region. Thus, in the damping force generating mechanism 81A, the third passage 168A expands the flow path cross-sectional area in accordance with an amount of opening of the valve disc 114A of the pressure valve 131A, and thus in the compression stroke in the medium to high speed range in which the piston speed is equal to or greater than the second predetermined value X2, the rate of increase in the damping force with respect to the increase in the piston speed is further lower and softer than in the compression stroke in the low speed range in which the piston speed is less than the second predetermined value X2.

In the compression stroke, the damping force characteristics due to the damping force generating mechanism 205 shown in FIG. 1 are also taken into account.

In the extension stroke, the piston 40A moves to the side of the upper chamber 41 and causes the pressure in the upper chamber 41 to increase and the pressure in the lower chamber 42 to decrease. In the extension stroke in the extremely low speed region in which the piston speed is equal to or less than the third predetermined value X3, the damping force generating mechanism 81A is in the neutral state, that is, the valve blocked state, and the damping force generating mechanism 91A is also in the valve blocked state. As a result, the oil liquid L in the upper chamber 41 flows into the lower chamber 42 via the orifice 243 of the intake valve 111A, the first passage 85A, and the passages in the plurality of passage holes 261 of the valve member 183A. Thus, a damping force having an orifice characteristic is generated by the orifice 243. Therefore, in the extension stroke in the extremely low speed region in which the piston speed is equal to or less than the third predetermined value X3, the damping force characteristic with respect to the piston speed becomes hard with the rate of increase in the damping force being relatively high with respect to the increase in the piston speed.

In the extension stroke in the low, medium, and high speed range in which the piston speed is greater than the third predetermined value X3, the pressure in the second passage 95A of the piston 40A which is communicated with the upper chamber 41 increases, and thus, in the damping force generating mechanism 91A, the valve member 183A including the plurality of discs 182A moves away from the outer valve seat portion 108A of the piston 40A. Then, the oil liquid L in the upper chamber 41 flows from the second passage 95A of the piston 40A to the lower chamber 42 via the passage between the valve member 183A and the outer valve seat portion 108A of the piston 40A. Thus, a damping force having valve characteristics is obtained. Therefore, in the extension stroke in the low, medium, and high speed range in which the piston speed is greater than the third predetermined value X3, the rate of increase in the damping force with respect to the increase in the piston speed is lower and softer than in the compression stroke in the extremely low speed range in which the piston speed is equal to or less than the third predetermined value X3.

In the cylinder device 11A, the damping force generating mechanism 81A that is provided in the first passage 85A through which the oil liquid L flows out as the piston 40A moves and that generates a damping force includes the intake valve 111A that opens and closes the first passage 85A, the slide valve 113A of which both the inner and outer circumferences are movable in the axial direction and which has the third passage 168A through which the oil liquid L flowing out of the first passage 85A can flow, and the pressure valve 131A of which the inner circumference is fixed and the outer circumference is bent to adjust the biasing force of the intake valve 111A. Therefore, in the cylinder device 11A, by changing a thickness of the valve disc 114A that constitutes the pressure valve 131A, it is possible to adjust the damping force in the low speed region in which the piston speed is small, the medium speed region in which the piston speed is higher than the low speed region, and the high speed region in which the piston speed is higher than the medium speed region, as in the cylinder device 11 of the first embodiment.

Furthermore, in the cylinder device 11A, the plurality of convex portions 162A are disposed to be spaced apart from each other in the circumferential direction on the side of the slide valve 113A facing the pressure valve 131A. The cylinder device 11A can adjust the set load of the pressure valve 131A by changing the height of the plurality of convex portions 162A. In addition, the cylinder device 11A can adjust the flow rate of the oil liquid L flowing from the lower chamber 42 to the upper chamber 41 by changing the number of convex portions 162A, in other words, the number and width of the radial groove portions 154A between the convex portions 162A. In other words, the cylinder device 11A can adjust opening flow rates of the slide valve 113A and the pressure valve 131A by changing the number of convex portions 162A, in other words, the number and width of the radial groove portions 154A between the convex portions 162A.

In addition, in the cylinder device 11A, the plurality of convex portions 162A cause the valve disc 114A of the pressure valve 131A to corrugate in the circumferential direction when the valve disc 114A is in contact with the slide valve 113A. In other words, the number and thickness of the convex portions 162A of the slide valve 113A are set so that the valve disc 114A corrugates in the circumferential direction when the valve disc 114A of the pressure valve 131A is in contact with the slide valve 113A. Thus, the cylinder device 11A can apply a desired set load to the intake valve 111A by, for example, the valve disc 114A.

In addition, in the cylinder device 11A, the support member 235 which supports the axial movement of the slide valve 113A is provided on the inner circumferential side of the slide valve 113A, and the support member 235 indirectly supports the inner circumference of the pressure valve 131A via the spacer 112A. In this way, since the support member 235 indirectly supports the inner circumference of the pressure valve 131A, it is possible to simplify the configuration. Therefore, it is possible to cube an increase in costs.

In addition, in the cylinder device 11A, since the inner end of the slide valve 113A in the radial direction is located outward with respect to the inner end of the first passage 85A of the piston 40A in the radial direction, the radial thickness of the slide valve 113A can be made thin. Therefore, the slide valve 113A can be made lighter, and responsiveness of the movement of the slide valve 113A can be improved.

In addition, in the cylinder device 11A, since the support member 235 that supports the axial movement of the slide valve 113A has the base portion 251 fixed to the piston rod 45 and the plurality of extension portions 252 that extend from the base portion 251 and can come into contact with the inner circumferential surface of the support member 235, and the plurality of extension portions 252 form the third passage 168A between them, the radial thickness of the slide valve 113A can be reduced while the third passage 168A inside the slide valve 113A is ensured. Therefore, the slide valve 113A can be made lighter, and the responsiveness of the movement of the slide valve 113A can be improved.

### Third Embodiment

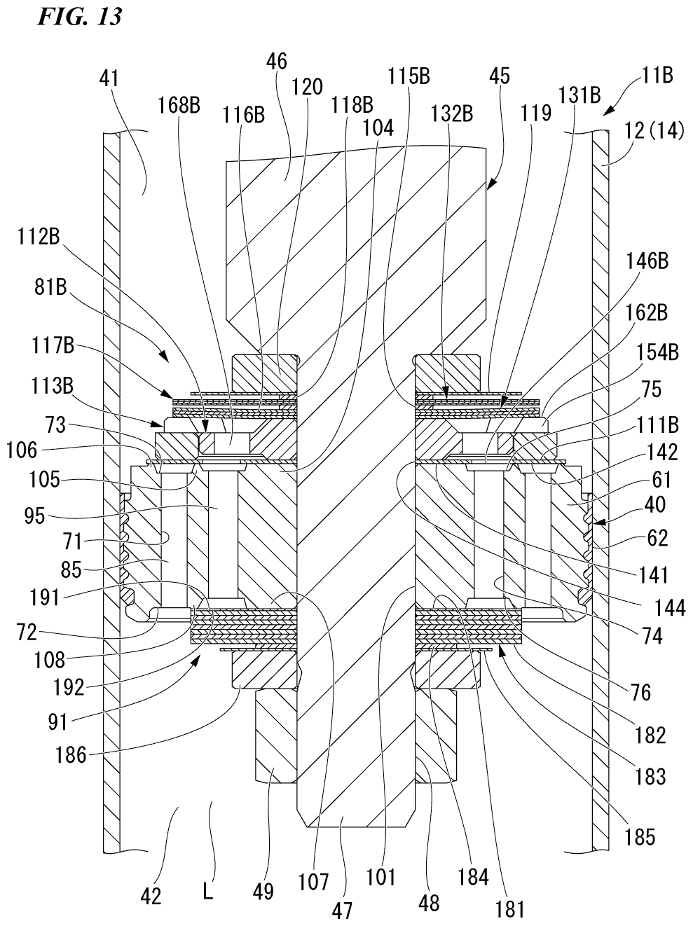

Next, a cylinder device according to a third embodiment of the present invention will be described mainly based on FIGS. 13 to 17, focusing on parts that are the same as those in the first embodiment, with reference to FIGS. 1 to 8. Parts that are common to those in the first embodiment will be designated by the same names and symbols.

### <Configuration>

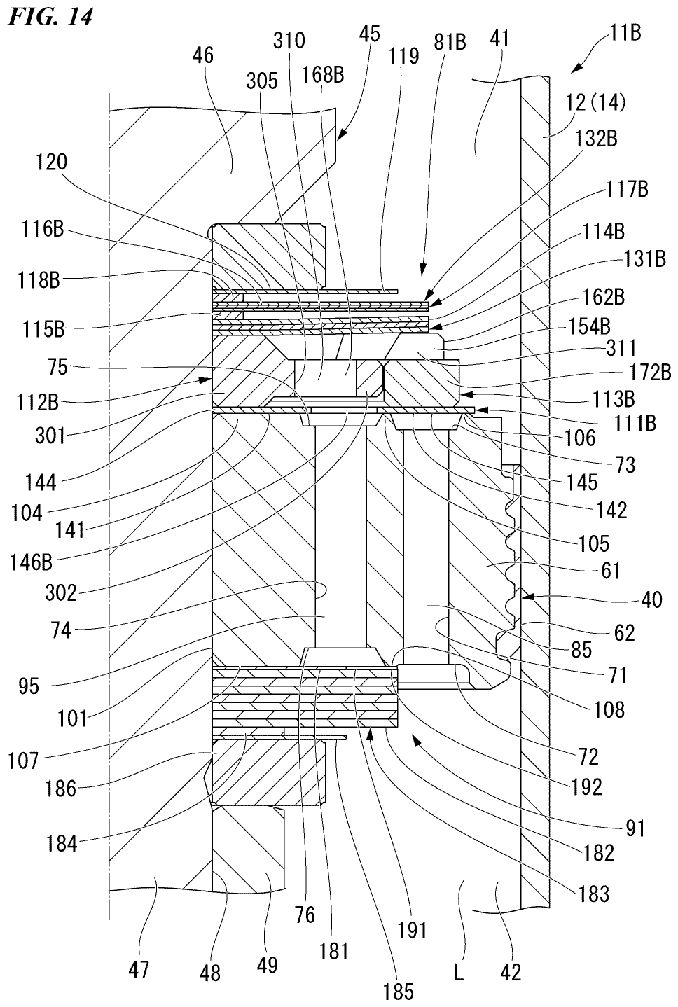

As shown in FIGS. 13 and 14, the cylinder device 11B of the third embodiment is partially different from the cylinder device 11 of the first embodiment in the configuration between the piston 40 and the backup disc 119.

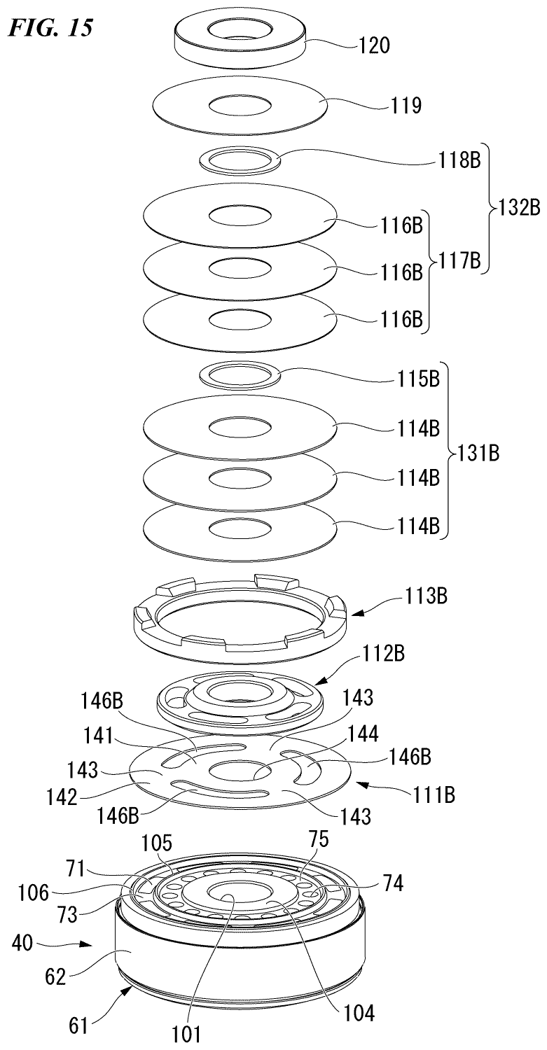

As shown in FIG. 14, in a state in which the mounting shaft portion 47 is inserted inward in the radial direction between the piston 40 and the backup disc 119, one intake valve 111B, one support member 112B, one slide valve 113B (a second valve), a plurality of valve discs 114B, one retainer 115B, a valve member 117B configured of a plurality of discs 116B, and one retainer 118B are provided in this order from the side of the piston 40 on the mounting shaft portion 47 of the piston rod 45. As shown in FIG. 15, the valve disc 114B and the retainer 115B constitute a first stage valve 131B (a third valve). The valve member 117B and the retainer 118B constitute a second stage valve 132B (a fourth valve).

As shown in FIG. 14, the intake valve 111B, the support member 112B, the valve disc 114B, the retainer 115B, the disc 116B and the retainer 118B are positioned in the radial direction with respect to the mounting shaft portion 47 by inserting the mounting shaft portion 47 inward in the radial direction. In addition, at least inner circumferential sides of the intake valve 111B, the support member 112B, the valve disc 114B, the retainer 115B, the disc 116B and the retainer 118B, together with the backup disc 119 and washer 120, are sandwiched between the main shaft portion 46 of the piston rod 45 and the inner seat portion 104 of the piston 40 in a state in which they are pressurized in the axial direction. Therefore, at least the inner circumferential sides of the intake valve 111B, the support member 112B, the valve disc 114B, the retainer 115B, the disc 116B, and the retainer 118B are fixed to the mounting shaft portion 47 of the piston rod 45.

The intake valve 111B, the support member 112B, the one slide valve 113B, the valve disc 114B, the retainer 115B, the disc 116B, the retainer 118B, the backup disc 119, and the washer 120 constitute the damping force generating mechanism 81B. A shape of a contact surface of the slide valve 113B is not limited as long as it is a shape suitable for applying a set load to the intake valve 111B at a contact surface between the intake valve 111B and the slide valve 113B. For example, a cross-sectional shape of the slide valve 113B in a plane including the central axis may be flat, or may be convex toward the intake valve 111B. When the cross-sectional shape is convex, a position of the convexity with respect to the intake valve 111B can be set arbitrarily.

The intake valve 111B is partially different in configuration from the intake valve 111. As shown in FIG. 15, a plurality of connection portions 143, specifically, three connection portions 143 are provided on the intake valve 111B. The plurality of connection portions 143 are provided at equal intervals in the circumferential direction of the intake valve 111B. In the intake valve 111B, intake valve passages 146B between the second annular portion 142 and the first annular portion 141 are provided in the same number as the number of connection portions 143, specifically, three connection portions 143.

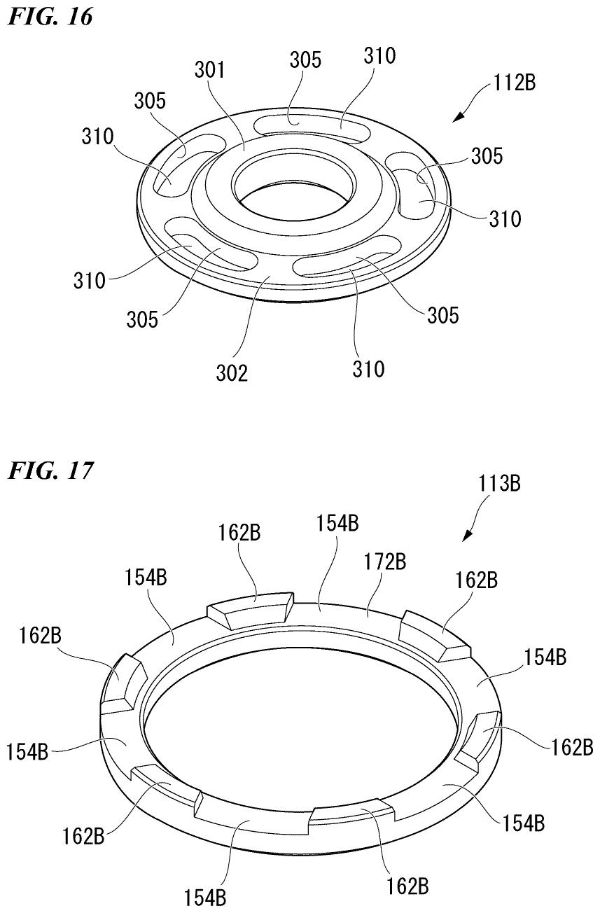

The support member 112B shown in FIG. 14 is made of a metal and has a circular plate shape. The mounting shaft portion 47 of the piston rod 45 is inserted through the inner side of the support member 112B in the radial direction. As shown in FIG. 16, the support member 112B has an annular boss portion 301 on the inner side in the radial direction and an annular passage forming portion 302 on the outer side in the radial direction. The passage forming portion 302 extends from the boss portion 301 to the outer side in the radial direction of the boss portion 301.

As shown in FIG. 14, in the support member 112B, the mounting shaft portion 47 of the piston rod 45 is inserted through the inner side of the boss portion 301 in the radial direction, and the support member 112B is fixed to the mounting shaft portion 47 at the boss portion 301. An outer diameter of an end portion of the boss portion 301 on the side of the piston 40 is smaller than the outer diameter of the first annular portion 141 of the intake valve 111B and smaller than the outer diameter of the inner seat portion 104 of the piston 40. The boss portion 301 of the support member 112B is in contact with the first annular portion 141.

The passage forming portion 302 is thinner in the axial direction than the boss portion 301, and extends radially outward from a middle position of the boss portion 301 in the axial direction. The passage forming portion 302 is provided biased toward the side of the piston 40 of the boss portion 301 in the axial direction. The passage forming portion 302 is axially spaced apart from the intake valve 111B in the blocked state. An outer diameter of the passage forming portion 302, in other words, an outer diameter of the support member 112B, is larger than the inner diameter of the second annular portion 142 of the intake valve 111B and smaller than the outer diameter of the inner valve seat portion 105 of the piston 40.

A passage hole 305 that passes through the passage forming portion 302 in the axial direction of the passage forming portion 302 is formed in the passage forming portion 302. The passage hole 305 is aligned with the intake valve passage 146B of the intake valve 111B in the radial direction of the support member 112B, and communicates with the intake valve passage 146B. As shown in FIG. 16, the passage hole 305 is an arc-shaped elongated hole that extends in the circumferential direction of the passage forming portion 302. In the passage forming portion 302, a plurality of, specifically five passage holes 305 having the same shape are formed at equal intervals in the circumferential direction of the passage forming portion 302 at positions equidistant from the central axis of the support member 112B.

In the support member 112B, the inside of the passage hole 305 defines a passage portion 310. The passage portion 310 and a passage portion 311 of a slide valve 113B (described below) define a third passage 168B. The passage portion 310 can communicate with the first passage 85 via the intake valve passage 146B of the intake valve 111B and the passage between the intake valve 111B and the inner valve seat portion 105 of the piston 40 which are spaced apart from each other. When the intake valve 111B moves away from the inner valve seat portion 105 of the piston 40, the passage portion 310 communicates with the first passage 85 and allows the oil liquid L flowing out of the first passage 85 to flow therethrough.

The slide valve 113B is made of a metal and has an annular shape. The slide valve 113B is formed by sintering or cutting.

As shown in FIG. 17, the slide valve 113B has an annular portion 172B and a convex portion 162B.

The annular portion 172B has an annular shape with a constant height in the axial direction and a constant width in the radial direction.

The convex portion 162B protrudes from one axial end surface of the annular portion 172B outward in the axial direction of the annular portion 172B. The convex portion 162B is formed up to the outer circumferential surface of the annular portion 172B in the radial direction of the annular portion 172B, but does not extend to the inner circumferential surface of the annular portion 172B. In other words, the convex portion 162B is formed in a range from the outer circumferential surface of the annular portion 172B to just before the inner circumferential surface of the annular portion 172B.

The slide valve 113B has a plurality of, specifically six, convex portions 162B of the same shape that protrude from the annular portion 172B to the same side in the axial direction of the annular portion 172B and are spaced apart at equal intervals in the circumferential direction of the annular portion 172B. The plurality of convex portions 162B are provided at positions equidistant from the central axis of the annular portion 172B. In the outer tip end surfaces of the plurality of convex portions 162B of the slide valve 113B in the axial direction of the slide valve 113B, inner edge portions of the slide valve 113B in the radial direction are disposed on the same circle. In the outer tip end surfaces of the plurality of convex portions 162B of the slide valve 113B in the axial direction of the slide valve 113B, outer edge portions of the slide valve 113B in the radial direction are also disposed on the same circle.

In the slide valve 113B, a space between the adjacent convex portions 162B in the circumferential direction of the annular portion 172B forms a radial groove portion 154B that passes through the slide valve 113B in the radial direction and opens to the side opposite to the annular portion 172B in the axial direction of the slide valve 113B. In the slide valve 113B, radial groove portions 154B of the same shape are formed between all of the convex portions 162B adjacent to each other in the circumferential direction of the slide valve 113B. Therefore, a plurality of radial groove portions 154B of the same shape, which is the same number as the number of convex portions 162B, specifically six, at equal intervals in the circumferential direction of the slide valve 113B are formed in the slide valve 113B.

As shown in FIG. 14, an outer diameter of the slide valve 113B is smaller than the outer diameter of the intake valve 111B. An inner diameter of the annular portion 172B, which is the inner diameter of the slide valve 113B, is slightly larger than the outer diameter of the support member 112B. A radius of the inner diameter side of the slide valve 113B is smaller than a minimum distance from the central axis of the piston 40A to the first passage 85 and larger than a maximum distance from the central axis of the piston 40A to the second passage 95. In other words, an inner end of the slide valve 113B in the radial direction is located outward with respect to the inner end of the second passage 95 of the piston 40A in the radial direction.

The slide valve 113B is placed on the second annular portion 142 of the intake valve 111B at the annular portion 172B in a state in which the convex portion 162B faces the side opposite to the intake valve 111B in the axial direction and the support member 112B are disposed inward in the radial direction. At this time, the slide valve 113B is positioned in the radial direction by the passage forming portion 302 of the support member 112B provided on the inner side of the annular portion 172B in the radial direction. That is, even when the slide valve 113B attempts to move in the radial direction, it comes into contact with the passage forming portion 302 of the support member 112B, and the movement in the radial direction is restricted. The support member 112B has the boss portion 301 fixed to the piston rod 45, and the passage forming portion 302 that extends from the boss portion 301 and capable of coming into contact with the inner circumferential surface of the support member 112B, and the passage forming portion 302 supports the axial movement of the slide valve 113B while restricting the radial movement of the slide valve 113B. The support member 112B supports the slide valve 113A at the passage forming portion 302 that forms the outer end in the radial direction, and has the passage portion 310 in the passage hole 305 that passes therethrough in the axial direction on the inner side with respect to the outer end in the radial direction. An inner diameter of the slide valve 113B is larger than the inner diameter of the second annular portion 142 of the intake valve 111B.

An axial length of the slide valve 113B, that is, an axial distance between the opposed end surfaces of the annular portion 172B and the plurality of convex portions 162B, is slightly longer than an axial length of the support member 112B which is the axial length of the boss portion 301.

In the slide valve 113B, a space inside the plurality of radial groove portions 154B forms a passage portion 311. The passage portion 311 communicates with the passage portion 310 of the support member 112B. The passage portion 311 and the passage portion 310 together define a third passage 168B. When the third passage 168B having the passage portions 310 and 311 communicates with the first passage 85 at the passage portion 310, it communicates the first passage 85 with the upper chamber 41.

The valve disc 114B constituting the first stage valve 131B is made of a metal and has a circular flat plate shape with a hole before being assembled to the piston rod 45. The valve disc 114B is formed by press molding from a single flat plate material. The valve disc 114B has a constant radial width over the entire circumference. The mounting shaft portion 47 of the piston rod 45 is inserted through the inner side of the valve disc 114B in the radial direction. A plurality of valve discs 114B having the same shape overlap each other to form the first stage valve 131B.

As described above, in the outer tip surfaces of the plurality of convex portions 162 of the slide valve 113B in the axial direction of the slide valve 113B, inner edge portions of the slide valve 113B in the radial direction are disposed on the same circle, but an outer diameter of the valve disc 114B is larger than a diameter of the circle. In addition, an axial thickness of the support member 112B is slightly thinner than an axial thickness of the slide valve 113B at the positions of the plurality of convex portions 162B, that is, a distance between the end surfaces of the convex portions 162B and the annular portion 172B that face each other in the axial direction of the slide valve 113B. Therefore, even when the slide valve 113B is in contact with the second annular portion 142 of the intake valve 111B at the annular portion 172B, and the second annular portion 142 is also in contact with the inner valve seat portion 105 and the outer valve seat portion 106 of the piston 40, the valve disc 114B is in contact with the plurality of convex portions 162B of the slide valve 113B, and the outer circumferential side thereof is bent so that it moves away from the piston 40 in the axial direction as it goes radially outward. At this time, the plurality of convex portions 162B are disposed to be spaced apart from each other in the circumferential direction on the side of the slide valve 113B opposite to the valve disc 114B. Therefore, when the valve disc 114B is in contact with the plurality of convex portions 162B of the slide valve 113B, a portion of the valve disc 114B that is not in contact with the plurality of convex portions 162B deforms in the axial direction so as to enter slightly into the radial groove portion 154B. Therefore, when the valve disc 114B comes into contact with the slide valve 113B, the plurality of convex portions 162B cause the valve disc 114B to corrugate in the circumferential direction.

In a state in which the outer circumferential side of the valve disc 114B is in contact with the plurality of convex portions 162B of the slide valve 113B, the valve disc 114B maximally blocks the passage portion 311 of the slide valve 113B that constitutes the third passage 168B, thereby minimizing an amount of communication between the third passage 168B and the upper chamber 41. When the outer circumference of the valve disc 114B bends and moves away from the plurality of convex portions 162B of the slide valve 113B in the axial direction, the valve disc 114B opens the passage portion 311 to increase the amount of communication between the third passage 168B and the upper chamber 41. In this way, the valve disc 114B is capable of opening and closing the third passage 168B. The valve disc 114B can bias the intake valve 111B via the slide valve 113B and can adjust a biasing force of the intake valve 111B.

The retainer 115B constituting the first stage valve 131B is made of a metal and has a circular flat plate shape with a hole. The retainer 115B is formed by press molding from a single flat plate material. The retainer 115B has a constant radial width over the entire circumference. The mounting shaft portion 47 of the piston rod 45 is inserted through the inner side of the retainer 115B in the radial direction. An outer diameter of the retainer 115B is smaller than an outer diameter of the valve disc 114B and smaller than an outer diameter of the boss portion 301 of the support member 112B.

The plurality of discs 116B of the valve member 117B constituting the second stage valve 132B are made of a metal and of the same shape. Each of the discs 116B has a circular flat plate shape with a hole. The discs 116B are formed by press molding from a single flat plate material. The disc 116B has a constant radial width over the entire circumference. The mounting shaft portion 47 of the piston rod 45 is inserted through the inner side of the disc 116B in the radial direction. The disc 116B has an outer diameter that is larger than the outer diameter of the retainer 115B and equal to the outer diameter of the intake valve 111B. The valve member 117B is configured by stacking the plurality of discs 116B in the axial direction. The valve member 117B can come into contact with the valve disc 114B, and the outer circumference thereof is bent to control an amount of movement of the valve disc 114B, in other words, an amount of valve opening.

The retainer 118B constituting the second stage valve 132B is made of a metal and has a circular flat plate shape with a hole. The retainer 118B is formed by press molding from a single flat plate material. The retainer 118B has a constant radial width over the entire circumference. The mounting shaft portion 47 of the piston rod 45 is inserted through the inner side of the retainer 118B in the radial direction. The outer diameter of the retainer 118B is smaller than the outer diameter of the valve member 117B and equal to the outer diameter of the retainer 115B.

The slide valve 113B is entirely movable in the axial direction with respect to the piston rod 45, that is, with respect to the support member 112B, that is, the piston rod 45 to which the support member 112B is fixed. In other words, both the inner and outer circumferences of the slide valve 113B are movable in the axial direction with respect to the support member 112B and the piston rod 45. The support member 112B is provided on the inner circumferential side of the slide valve 113B to support the axial movement of the slide valve 113B, and has a passage portion 310 of the third passage 168B through which the oil liquid L flowing out of the first passage 85 can flow.

When a pressure difference between the upper chamber 41 and the lower chamber 42 is in a neutral state in which it is less than a first differential pressure value, the second annular portion 142 of the intake valve 111B comes into contact with the inner valve seat portion 105 and the outer valve seat portion 106 of the piston 40, thereby blocking the first passage 85 at the blocking portion 145. In addition, in this neutral state, the valve disc 114B of the first stage valve 131B comes into contact with the plurality of convex portions 162 of the slide valve 113B in a state in which the outer circumferential side is bent in the axial direction toward the side opposite to the piston 40. A biasing force of the valve disc 114B generated at this time causes the slide valve 113B to be positioned closest to the piston 40. Furthermore, due to the biasing force of the valve disc 114B generated at this time, the slide valve 113B presses the second annular portion 142 of the intake valve 111B against the inner valve seat portion 105 and the outer valve seat portion 106 of the piston 40 and bring the second annular portion 142 into contact with them.

When a pressure in the lower chamber 42 becomes higher than the pressure in the upper chamber 41 by the first differential pressure value or more, in the damping force generating mechanism 81B, the second annular portion 142 of the intake valve 111B moves away from the inner valve seat portion 105 and the outer valve seat portion 106 of the piston 40 while moving the slide valve 113B to side opposite to the piston 40. Then, the oil liquid L in the lower chamber 42 flows from the first passage 85 to the upper chamber 41 via a passage between the second annular portion 142 of the intake valve 111B and the outer valve seat portion 106 of the piston 40. At the same time, the oil liquid L in the lower chamber 42 flows from the first passage 85 to the upper chamber 41 via a passage between the second annular portion 142 of the intake valve 111B and the inner valve seat portion 105 of the piston 40, the intake valve passage 146B of the intake valve 111B, and the third passage 168B including the passage portion 310 of the support member 112B and the passage portion 311 inside the plurality of radial groove portions 154B of the slide valve 113B. At this time, the valve disc 114B of the first stage valve 131B is in contact with the plurality of convex portions 162B of the slide valve 113B and blocks the third passage 168B maximally. When the slide valve 113B moves to the side opposite to the piston 40, it moves while deforming the valve disc 114B, and the valve disc 114B is deformed while deforming the valve member 117B.

When the pressure in the lower chamber 42 becomes higher than the pressure in the upper chamber 41 by a second differential pressure value or more that is higher than the first differential pressure value, in addition to the above, the valve disc 114B of the first stage valve 131B moves away from the plurality of convex portions 162 of the slide valve 113B while deforming the valve member 117B of the second stage valve 132B, and opens the third passage 168B. Therefore, the oil liquid L in the lower chamber 42 flows from the first passage 85 to the upper chamber 41 via the passage between the second annular portion 142 of the intake valve 111B and the outer valve seat portion 106 of the piston 40. At the same time, the oil liquid L in the lower chamber 42 flows from the first passage 85 to the upper chamber 41 via the passage between the second annular portion 142 of the intake valve 111B and the inner valve seat portion 105 of the piston 40, the intake valve passage 146B of the intake valve 111B, and the third passage 168B including the passage portion 310 of the support member 112B and the passage portion 311 in the plurality of radial groove portions 154B of the slide valve 113B. At this time, the valve disc 114B of the first stage valve 131B is spaced apart from the plurality of convex portions 162B of the slide valve 113B in the axial direction, and opens the third passage 168B.

### <Operation>

In the compression stroke, the piston 40 moves to the side of the lower chamber 42 to increase the pressure in the lower chamber 42 and to decrease the pressure in the upper chamber 41. In the compression stroke in an extremely low speed region in which the piston speed which is an axial movement speed of the piston 40 is equal to or less than a first predetermined value X1, the damping force generating mechanism 81B is in a neutral state, that is, a valve blocked state, and the damping force generating mechanism 91 is also in a valve blocked state. As a result, the oil liquid L in the lower chamber 42 flows into the upper chamber 41 through the orifice 192 of the orifice disc 181, the second passage 95 of the piston 40, the intake valve passage 146B of the intake valve 111B, and the third passage 168B including the passage portion 310 of the support member 112B and the passage portion 311 in the plurality of radial groove portions 154B of the slide valve 113B. Thus, a damping force having orifice characteristics (the damping force is approximately proportional to the square of the piston speed) is generated by the orifice 192. Therefore, in the compression stroke in the extremely low speed region in which the piston speed is equal to or less than the first predetermined value X1, the characteristics of the damping force with respect to the piston speed become hard with a rate of increase in the damping force becoming relatively high with respect to the increase in the piston speed.

In the compression stroke in a low speed region in which the piston speed is greater than the first predetermined value X1 and less than a second predetermined value X2 that is greater than the first predetermined value X1, the pressure in the first passage 85 communicating with the lower chamber 42 increases, and thus, in the damping force generating mechanism 81B, the second annular portion 142 of the intake valve 111B moves the slide valve 113B to the side opposite to the piston 40, and moves away from the inner valve seat portion 105 and the outer valve seat portion 106 of the piston 40 while deforming the outer circumferential sides of the valve disc 114B of the first stage valve 131B and the valve member 117B of the second stage valve 132B to the side opposite side to the piston 40. Then, the oil liquid L in the lower chamber 42 flows from the first passage 85 to the upper chamber 41 via a passage between the second annular portion 142 of the intake valve 111B and the outer valve seat portion 106 of the piston 40. At the same time, the oil liquid L in the lower chamber 42 flows from the first passage 85 to the upper chamber 41 via the passage between the second annular portion 142 of the intake valve 111B and the inner valve seat portion 105 of the piston 40, the intake valve passage 146B of the intake valve 111B, and the third passage 168B including the passage portion 310 of the support member 112B and the passage portion 311 in the plurality of radial groove portions 154B of the slide valve 113B. At this time, the outer circumferential side of the valve disc 114B is in contact with the plurality of convex portions 162B of the slide valve 113B and blocks the third passage 168B maximally. In the compression stroke in the low speed range, in the damping force generating mechanism 81B, the passage between the second annular portion 142 of the intake valve 111B and the outer valve seat portion 106 of the piston 40 and the passage between the second annular portion 142 of the intake valve 111B and the inner valve seat portion 105 of the piston 40 expands expand their own flow path cross-sectional areas as the piston speed increases, thereby obtaining a damping force with valve characteristics (characteristics in which the damping force is approximately proportional to the piston speed). Therefore, in the compression stroke in the low speed region in which the piston speed is less than the second predetermined value X2, the rate of increase in damping force with respect to the increase in the piston speed is lower and softer than in the compression stroke in the extremely low speed region in which the piston speed is equal to or less than the first predetermined value X1.

In the compression stroke in a medium to high speed range in which the piston speed is equal to or greater than the second predetermined value X2, the second annular portion 142 of the intake valve 111B moves the slide valve 113B to the side opposite to the piston 40 further than in the low speed range. Then, the oil liquid L in the lower chamber 42 flows from the first passage 85 to the upper chamber 41 via the passage between the second annular portion 142 and the outer valve seat portion 106, which has a flow path cross-sectional area expanded more than in the low speed region. At the same time, the oil liquid L in the lower chamber 42 flows from the first passage 85 to the upper chamber 41 via the passage between the second annular portion 142 and the inner valve seat portion 105, which has a flow path cross-sectional area expanded more than in the low speed region, the intake valve passage 146B of the intake valve 111B, and the third passage 168B including the passage portion 310 of the support member 112B and the passage portion 311 in the plurality of radial groove portions 154B of the slide valve 113B. At this time, the oil liquid L flowing through the third passage 168B deforms the outer circumferential sides of the valve disc 114B of the first stage valve 131B and the valve member 117B of the second stage valve 132B to the side opposite to the piston 40 more than in the low speed region, and flows into the upper chamber 41 while moving the outer circumferential side of the valve disc 114B away from the plurality of convex portions 162 of the slide valve 113B. Therefore, the flow passage cross-sectional area of the third passage 168B is expanded larger than that in the low speed region. Thus, in the damping force generating mechanism 81B, the third passage 168B expands the flow path cross-sectional area in accordance with an amount of opening of the valve disc 114B of the first stage valve 131B, and thus in the compression stroke in the medium to high speed range in which the piston speed is equal to or greater than the second predetermined value X2, the rate of increase in the damping force with respect to the increase in the piston speed is further lower and softer than in the compression stroke in the low speed range in which the piston speed is less than the second predetermined value X2.

In the compression stroke, the damping force characteristics due to the damping force generating mechanism 205 shown in FIG. 1 are also taken into account.

In the extension stroke, the piston 40 moves to the side of the upper chamber 41 and causes the pressure in the upper chamber 41 to increase and the pressure in the lower chamber 42 to decrease. In the extension stroke in the extremely low speed region in which the piston speed is equal to or less than a third predetermined value X3, the damping force generating mechanism 81B is in the neutral state, that is, the valve blocked state, and the damping force generating mechanism 91 is also in the valve blocked state. As a result, the oil liquid L in the upper chamber 41 flows into the lower chamber 42 via the third passage 168B including the passage portion 311 in the plurality of radial groove portions 154B of the slide valve 113B and the passage portion 310 of the support member 112B, the intake valve passage 146B of the intake valve 111B, the second passage 95 of the piston 40, and the orifice 192 of the orifice disc 181. Thus, a damping force having an orifice characteristic is generated by the orifice 192. Therefore, in the extension stroke in the extremely low speed region in which the piston speed is equal to or less than the third predetermined value X3, the damping force characteristic with respect to the piston speed becomes hard with the rate of increase in the damping force being relatively high with respect to the increase in the piston speed.

In the extension stroke in the low, medium, or high speed range in which the piston speed is greater than the third predetermined value X3, the pressure increases in the third passage 168B including the passage portions 311 in the plurality of radial groove portions 154B of the slide valve 113B and the passage portion 310 of the support member 112B, the intake valve passage 146B of the intake valve 111B, and the second passage 95 of the piston 40 which are communicated with the upper chamber 41, and thus, in the damping force generating mechanism 91, the valve member 183 including the orifice disc 181 and the plurality of discs 182 moves away from the valve seat portion 108 of the piston 40. Then, the oil liquid L in the upper chamber 41 flows from the third passage 168B including the passage portions 311 of the plurality of radial groove portions 154B of the slide valve 113B and the passage portion 310 of the support member 112B, the intake valve passage 146B of the intake valve 111B and the second passage 95 of the piston 40 into the lower chamber 42 via the passage between the valve member 183 and the valve seat portion 108 of the piston 40. Thus, a damping force having valve characteristics is obtained. Therefore, in the extension stroke in the low, medium, and high speed range in which the piston speed is greater than the third predetermined value X3, the rate of increase in the damping force with respect to the increase in the piston speed is lower and softer than in the compression stroke in the extremely low speed range in which the piston speed is equal to or less than the third predetermined value X3.

The cylinder device 11B includes the damping force generating mechanism 81B that is provided in the first passage 85 through which the oil liquid L flows out as the piston 40 moves and that generates a damping force, the intake valve 111B that opens and closes the first passage 85, the slide valve 113B of which both inner and outer circumferences are movable in the axial direction, the support member 112B that is provided on the inner circumferential side of the slide valve 113B and has the passage portion 310 of the third passage 168A that supports the axial movement of the slide valve 113B and allows the oil liquid L flowing out of the first passage 85 to flow therethrough, and the first stage valve 131B of which an inner circumference is fixed and an outer circumference is flexible as to adjust a biasing force of the intake valve 111B. Therefore, in the cylinder device 11B, for example, by changing the thickness of the valve disc 114B and the retainer 115B that constitute the first stage valve 131B, the damping force in the low speed region in which the piston speed is low can be adjusted to be harder or softer, and the damping force in the medium speed region in which the piston speed is higher than the low speed region and the high speed region in which the piston speed is higher than the medium speed region can be adjusted to be harder or softer. In this way, the cylinder device 11B is capable of adjusting the damping force in the low speed region in which the piston speed is low, the medium speed region in which the piston speed is higher than in the low speed region and the high speed region in which the piston speed is higher than in the medium speed region.

Furthermore, since the cylinder device 11B includes the second stage valve 132B similar to the second stage valve 132, the second stage valve 132B can provide the same effect as in the second stage valve 132.

In addition, in the cylinder device 11B, since the slide valve 113B has the plurality of convex portions 162B similar to the plurality of convex portions 162 of the slide valve 113, the plurality of convex portions 162B can provide the same effect as in the plurality of convex portions 162.

In addition, the cylinder device 11B is provided with the support member 112B on the inner circumference side of the slide valve 113B to support the axial movement of the slide valve 113B, and the support member 112B directly supports the inner circumference of the first stage valve 131B. In this way, since the support member 112B directly supports the inner circumference of the first stage valve 131B, it is possible to simplify the configuration. Therefore, it is possible to reduce costs.

Furthermore, in the cylinder device 11B, since the inner end of the slide valve 113B in the radial direction is located outward with respect to the inner end of the second passage 95 of the piston 40 in the radial direction, the radial thickness of the slide valve 113B can be made thin. Therefore, the slide valve 113B can be made lighter, and the responsiveness of the movement of the slide valve 113B can be improved.

Furthermore, in the cylinder device 11B, since the support member 112B that supports the axial movement of the slide valve 113B has the boss portion 301 fixed to the piston rod 45 and the passage forming portion 302 that extends from the boss portion 301 and can come into contact with the inner circumferential surface, the radial thickness of the slide valve 113B can be reduced while the passage portion 310 of the third passage 168B is secured in the passage forming portion 302 inside the slide valve 113B. Therefore, the slide valve 113B can be made lighter, and the responsiveness of the movement of the slide valve 113B can be improved.

### INDUSTRIAL APPLICABILITY

According to the cylinder device of the above aspect of the present invention, it is possible to provide a cylinder device that is capable of adjusting a damping force in a low speed region in which a piston speed is low, a medium speed region in which the piston speed is higher than the low speed region, and a high speed region in which the piston speed is higher than the medium speed region.

### EXPLANATION OF REFERENCES

11, 11A, 11B Cylinder device
14 Cylinder
40, 40A Piston
41 Upper chamber (chamber)
42 Lower chamber (chamber)
45 Piston rod
81, 81A, 81B Damping force generating mechanism
85, 85A First passage
95, 95A Second passage
111, 111A, 111B Intake valve (first valve)
113, 113A, 113B Slide valve (second valve)
131 First stage valve (third valve)
131A Pressure valve (third valve)
132 Second stage valve (fourth valve)
141 First annular portion
142 Second annular portion
143 Connection portion
144 Insertion hole
145 Blocking portion
162, 162A, 162B Convex portion
168, 168A, 168B Third passage
L Oil liquid (working fluid)

What is claimed is:

1. A cylinder device comprising:
a cylinder in which a working fluid is sealed;
a piston slidably provided within the cylinder and configured to divide an inside of the cylinder into two chambers;
a piston rod connected to the piston and configured to extend to an outside of the cylinder;
a first passage through which the working fluid flows as the piston moves;
a second passage through which the working fluid flows as the piston moves; and
a damping force generating mechanism provided to the first passage and configured to generate a damping force,
wherein the damping force generating mechanism includes a first valve that opens and closes the first passage, a second valve of which inner and outer circumferences are both movable in an axial direction and which has a third passage through which the working fluid flowing out of the first passage flows, and a third valve of which an inner circumference is fixed and an outer circumference is bent to adjust a biasing force of the first valve.

2. The cylinder device according to claim 1, further comprising a fourth valve of which an inner circumference is fixed and an outer circumference is bent to apply an additional biasing force on the third valve to set the third valve at a predetermined distance in the axial direction.

3. The cylinder device according to claim 1, further comprising a fourth valve of which an inner circumference is fixed and an outer circumference is bent to control an amount of movement of the third valve.

4. The cylinder device according to claim 2, wherein the first valve has a first annular portion having an insertion hole through which the piston rod is inserted, a second annular portion having a blocking portion that blocks the first passage and an inner diameter that is larger than an outer diameter of the first annular portion, and a connection portion that connects the first annular portion and the second annular portion to each other in a radial direction.

5. The cylinder device according to claim 1, wherein a plurality of convex portions are disposed on a side of the second valve opposite to the third valve to be spaced apart from each other in a circumferential direction.

6. The cylinder device according to claim 5, wherein the plurality of convex portions cause the third valve to corrugate in the circumferential direction when the third valve is in contact with the second valve.

7. The cylinder device according to claim 1, wherein a support member that supports axial movement of the second valve is provided on an inner circumferential side of the second valve, and
the support member directly or indirectly supports an inner circumference of the third valve.

8. A cylinder device comprising:
a cylinder in which a working fluid is sealed;
a piston slidably disposed within the cylinder and configured to divide an inside of the cylinder into two chambers;
a piston rod connected to the piston and configured to extend to an outside of the cylinder;
a first passage through which the working fluid flows as the piston moves;
a second passage through which the working fluid flows as the piston moves; and
a damping force generating mechanism provided to the first passage and configured to generate a damping force,
wherein the damping force generating mechanism includes:
a first valve that opens and closes the first passage;
a second valve of which inner and outer circumferences are both movable in an axial direction;
a support member provided on an inner circumferential side of the second valve to support axial movement of the second valve and having a third passage configured to allow the working fluid flowing from the first passage to flow therethrough; and
a third valve of which an inner circumference is fixed and an outer circumference is flexible to adjust a biasing force of the first valve.
